(19) United States
(12) Patent Application Publication
(10) Pub. No.: US 2024/0194895 A1
(43) Pub. Date: Jun. 13, 2024

(54) METHODS AND COMPOSITIONS FOR ELECTROCATALYTIC SURFACE NANOIONICS FOR ENHANCING DURABILITY AND PERFORMANCE OF SOLID OXIDE CELLS

(71) Applicant: WEST VIRGINIA UNIVERSITY BOARD OF GOVERNORS ON BEHALF OF WEST VIRGINIA UNIVERSITY, Morgantown, WV (US)

(72) Inventors: Xueyan SONG, Pittsburgh, PA (US); Yun CHEN, Pittsburgh, PA (US)

(21) Appl. No.: 18/287,636

(22) PCT Filed: Apr. 19, 2022
(86) PCT No.: PCT/US2022/025351

§ 371 Date: Oct. 19, 2023

Related U.S. Application Data
(60) Provisional application No. 63/176,672, filed on Apr. 19, 2021.

(51) Int. Cl. H01M 4/86; H01M 4/88; H01M 4/90; H01M 4/92

(52) U.S. Cl. CPC H01M 4/8657; H01M 4/8867; H01M 4/9033; H01M 4/925; H01M 2004/8689

(57) ABSTRACT

In one aspect, the disclosure relates to ALD-coated cells comprising a conformal ultra-thin nanocomposite comprising Pt and CoOₓ on a LSCF/SDC cathode backbone. In a further aspect, the ALD-coated cells comprising an ultra-thin nanocomposite comprising Pt and CoOₓ on a LSCF/SDC cathode backbone are prepared using a disclosed Atomic Layer Deposition (ALD) coating method. In a still further aspect, the disclosed ALD-coated cells comprise a heterogeneous coating layer comprising subjacent discrete Pt nanoparticles capped with superjacent fully dense conformal CoOₓ layer. In a yet further aspect, the performance of the disclosed ALD-coated cells is improved compared to baseline cells lacking the disclosed ALD coating on a LSCF/SDC cathod backbone. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/176,672, filed on Apr. 19, 2021, which is incorporated herein by reference in its entirety.

### STATEMENT REGARDING FEDERALLY SPONSORED RESEARCH

This disclosure was made with U.S. Government support under grant numbers DE-FE0031665, DE-FE 0031251, and DE-FE0026167, awarded by the Department of Energy, and grant number NSF-DMR 1916581, award by the National Science Foundation. The U.S. government has certain rights in the disclosure.

### BACKGROUND

The rapid climate deterioration due to CO₂ emission and fossil fuel consumption has manifested the significance of technology developing for hydrogen that is an energy carrier with high energy density for versatile energy conversion with the minimum environmental impact. Solid oxide cells (SOCs) that can be powered by pure H₂ for electricity generation in the fuel cell mode and can work reversibly as an electrolyzer for H₂ production possess the unrivaled highest energy conversion efficiencies among all the competing technologies (Ref. 1). However, for stationary electricity generation with a long-term of 3-5 years, the current state-of-the-art solid oxide fuel cells (SOFCs) continuously face electrode degradation challenges. Developing more robust electrodes are still the top priority for SOCs development. In terms of the oxygen electrode, the current state-of-the-art high-performance electrode commonly employs a cobaltite-based perovskite, including lanthanum strontium cobalt ferrite (LSCF; Ref. 2). LSCF has a high ionic and electrical conductivity, high oxygen self-diffusion coefficient, and oxygen surface exchange coefficient. As an effective electrocatalyst, LSCF cathodes have active areas for oxygen reduction reaction across the entire surface.

Nevertheless, LSCF cathode presents inadequate long-term durability due to intrinsic materials degradation of Sr segregation (Refs. 3-8). For the SOFC stacks, electrode degradation caused by Sr surface segregation is further accelerated due to their interaction with the volatile Cr species that are evaporated from the Cr-containing interconnects. Although various solution-based infiltration has been developed to decorate the internal surface of the porous oxygen-electrode (Refs. 9-10) its impact on enhancing the stability of the LSCF appears to be limited partially due to the discrete nature of the infiltrated materials with uncontrolled microstructure. To effectively mitigate the Sr surface segregation and Cr contamination, it is essential to have a conformal surface coating layer inert to both Sr and Cr and serving as the barrier for Sr outward diffusion and Cr inward diffusion. On the other aspect, completely sealing off the LSCF/SDC backbone surface leads to the loss of cathode electroactivity. So, such a coating layer must be capable of carrying sufficient electrocatalytic activity for the oxygen reduction reaction (ORR). Plus, this coating layer needs to possess sufficiently high ionic conductivity to facilitate subsequent mass transfer for the dissociated oxygen ions.

Other than the aforementioned strict requirement in terms of the chemistry, conformity, and electrochemical properties, the coating layer also needs to be applied to the internal surface of the porous electrode that possesses complex topography with a high aspect ratio. Furthermore, the nanostructured materials are thermally sensitive at a modest temperature of ˜400° C. (Refs. 11-12) because of the large surface-to-volume ratio and high surface energy of nanocrystals. Accordingly, there is an enormous concern about the structural stability of nanocrystals in the coating layer at elevated temperatures for the desired lifetime. Therefore, developing a conformal coating to mitigate the Sr surface segregation in SOFCs, while maintaining the electrode's functionality is incredibly sophisticated.

Despite advances in solid oxide fuel cells (SOFCs) research, there is still a scarcity of materials and fabrication methods to address current issues and constraints around electrode degradation. These needs and other needs are satisfied by the present disclosure.

### SUMMARY

In accordance with the purpose(s) of the disclosure, as embodied and broadly described herein, the disclosure, in one aspect, relates to ALD-coated cells comprising a conformal ultra-thin nanocomposite comprising Pt and CoOₓ on a LSCF/SDC cathode backbone. In a further aspect, the ALD-coated cells comprising an ultra-thin nanocomposite comprising Pt and CoOₓ on a LSCF/SDC cathode backbone are prepared using a disclosed Atomic Layer Deposition (ALD) coating method. In a still further aspect, the disclosed ALD-coated cells comprise a heterogeneous coating layer comprising subjacent discrete Pt nanoparticles capped with superjacent fully dense conformal CoOₓ layer. In a yet further aspect, the performance of the disclosed ALD-coated cells is improved compared to baseline cells lacking the disclosed ALD coating on a LSCF/SDC cathod backbone.

Disclosed herein are coated electrodes comprising: an electrode comprising a nanocomposite coating; wherein the nanocomposite coating comprises: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof; wherein the first coating layer is subjacent to the second coating layer; and wherein the second coating layer is superjacent to the first coating layer, thereby capping the first coating layer.

Also disclosed herein nanocomposite coatings comprising: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof; wherein the first coating layer is subjacent to the second coating layer; and wherein the second coating layer is superjacent to the first coating layer, thereby capping the first coating layer.

Also disclosed herein are electrodes comprising a disclosed nanocomposite coating on at least one surface of the electrode.

Also disclosed herein are products comprising a disclosed electrode.

Also disclosed herein are solid oxide cells comprising a disclosed electrode.

Also disclosed herein are heterogenous nanocomposite coatings comprising; at least two layers, wherein one layer of the coating is a subjacent discrete Pt nanoparticles layer and a second layer of the coating is a layer that caps the Pt nanoparticles layer with a superjacent CoOₓ layer.

Also disclosed are articles comprising a substrate with a disclosed nanocomposite coating on at least one surface of the substrate.

Also disclosed are products comprising a disclosed article.

Also disclosed are methods of making a disclosed coated electrode, the method comprising: providing an electrode in an atomic layer deposition reaction chamber; performing at least one atomic layer deposition cycle to form a first coating layer on a surface of the substrate; wherein the first coating layer comprises discrete nanoparticles; wherein the discrete nanoparticles comprise Pt, Ag, Au, or combinations thereof; performing at least one atomic layer deposition cycle to form a second coating layer on the first coating layer; wherein the second coating layer comprises metal oxide nanograins; wherein the metal oxide nanograins comprise Co_{y}Oₓ; doped Co_{y}Oₓ; Pr_{y}Oₓ; doped Pr_{y}Oₓ; CeOₓ; doped CeOₓ; La_{y}Ni_{z}Oₓ; doped La_{y}Ni_{z}Oₓ; or combinations thereof; and wherein the second coating layer forms a continuous conformal layer comprising metal oxide nanograins on the first coating layer; wherein the first coating layer is subjacent to the second coating layer; and wherein the second coating layer is superjacent to the first coating layer, thereby capping the first coating layer; wherein the first coating layer is superjacent to the substrate.

Also disclosed are methods of providing a disclosed nanocomposite coating on a substrate, the method comprising: providing a substrate an atomic layer deposition reaction chamber; performing at least one atomic layer deposition cycle to form a first coating layer on a surface of the substrate; wherein the first coating layer comprises discrete nanoparticles; wherein the discrete nanoparticles comprise Pt, Ag, Au, or combinations thereof; performing at least one atomic layer deposition cycle to form a second coating layer on the first coating layer; wherein the second coating layer comprises metal oxide nanograins; wherein the metal oxide nanograins comprise Co_{y}Oₓ; doped Co_{y}Oₓ; Pr_{y}Oₓ; doped Pr_{y}Oₓ; CeOₓ; doped CeOₓ; La_{y}Ni_{z}Oₓ; doped La_{y}Ni_{z}Oₓ; or combinations thereof; and wherein the second coating layer forms a continuous conformal layer comprising metal oxide nanograins on the first coating layer; wherein the first coating layer is subjacent to the second coating layer; and wherein the second coating layer is superjacent to the first coating layer, thereby capping the first coating layer; wherein the first coating layer is superjacent to the substrate.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D show representative power density and impedence data for a baseline cell compared to a representative disclosed ALD-coated cell having a 2 nm Pt layer plus 10 nm CoOₓ. In the figure, “Baseline” indicates the baseline cell, and “ALD” refers to the representative disclosed ALD-coated cell. Electrochemical operation was carried out for the indicated times at 750° C. FIG. 1A shows terminal voltage as a function of current density for the baseline and ALD-coated cells. FIG. 1B shows Nyquist plots of four cells at 0.3 A/cm². FIG. 1C shows Bode plots for the baseline and ALD-coated cells at 0.3 A/cm². FIG. 1D shows corresponding deconvolution spectra of the impedance data collected from the baseline and ALD-coated cells.

FIGS. 2A-2D show representative transmission electron microscopy images of a representative disclosed ALD-coated cell having a 2 nm Pt layer plus 10 nm CoOₓ after operation at 750° C. for 502 h. FIG. 2A shows a representative conformal dense Co_{0.9}Fe_{0.1}Oₓ film covering the discrete Pt particles with a Sr-enriched interface phase between Co_{0.9}Fe_{0.1}Oₓ film and the LSCF backbone. FIG. 2B shows a representative STEM bright field imaging depicting the Co_{0.9}Fe_{0.1}Oₓ having single-layered nanograins with high-density intergranular grain boundaries and surface grain boundaries. The Sr-enriched layer is ˜2 nm thick. FIG. 2C shows a representative STEM dark-field imaging is taken from the direction of LSCF. The Sr-enriched layer is shown at the interface (brighter contrast indicating the enrichment of heavy element). FIG. 2D shows an enlarged box area from FIG. 2C which shows the region of the interface between the Sr-enriched phase and the LSCF grain as indicated by the dashed arrow. As these images show, the Sr-enriched interface is fully epitaxial and coherent with the LSCF grain, presenting the same atom arrangement of that LSCF grain. The Sr-enriched interface shares the same La/Sr site column intensity of LSCF. However, the Co/Fe site column intensity is much stronger than that of LSCF.

FIGS. 3A-3D show representative simulated STEM dark-field images from the boxed area in FIG. 2D. FIG. 3A shows detail of the boxed area in FIG. 2D. FIG. 3B shows simulated atom arrangement of the simulated area in FIG. 3A. In the Sr-enriched region, the La/Sr columns are the same as that of LSCF grain. However, 50% of Co/Fe atom columns are substituted by Sr. FIG. 3C shows the simulated atomic structure at the interface between the Sr-enriched interface phase and the LSCF, depicting the larger ionic size of Co/Fe site in the Sr-enriched phase. FIG. 3D shows the simulated 3D structure of the interface region.

FIGS. 4A-4D show representative power density and impedence data for a baseline cell compared to a representative disclosed ALD-coated cell having a 4 nm Pt layer plus 20 nm CoOₓ. In the figure, “Baseline” indicates the baseline cell, and “ALD” refers to the representative disclosed ALD-coated cell. Electrochemical operation was carried out for the indicated times at 750° C. FIG. 4A shows terminal voltage as a function of current density for the baseline and ALD-coated cells. FIG. 4B shows Nyquist plots of four cells at 0.3 A/cm². FIG. 4C shows Bode plots for the baseline and ALD-coated cells at 0.3 A/cm². FIG. 4D shows corresponding deconvolution spectra of the impedance data collected from the baseline and ALD-coated cells.

FIGS. 5A-5C show representative transmission electron microscopy images of a representative disclosed ALD-coated cell having a 4 nm Pt layer plus 20 nm CoOₓ after operation for 816 h at 650° C. FIG. 5A shows the as-deposited conformal fully dense ALD coating layer. FIG. 5B shows the conformal ALD film on LSCF backbone. FIG. 5C shows conformal ALD layer on SDC backbone.

FIGS. 6A-6H show representative schematic diagrams of the surface architecture of a baseline cell (FIG. 6A) compared to a representative disclosed ALD-coated cell (FIGS. 6C-6H), e.g., a LSCF cathode backbone with 8-10 nm Pt+CoOₓ layer. FIG. 6A shows a representative LSCF phase, SDC phase and their phase boundary (interface) in a baseline cell (uncoated cell). FIG. 6B shows representative ORR sites for baseline cells. FIG. 6C cell no. 2 cathode backbone with as-deposited conformal Pt+CoOₓ layer. FIG. 6D Surface layer after the electrochemical operation at 750 (or 650) ° C. FIG. 6E Distribution of electrocatalyst after the operation. FIG. 6G Distribution of ionic conductor after the operation. FIG. 6G Distribution of electrical conductor after the operation. FIG. 6H Expected cathode active ORR sites for cell with a surface coating layer.

FIGS. 7A-7B show representative impedance data and impedance simulation results for a baseline cell (Cell No. 1, Table 1) at 30 h and 750° C. FIG. 7A shows impedance data and individual RQ contribution plots and their sum with the equivalent circuit model (schematically shown above the plot) used for simulation. FIG. 7B shows a Nyquist plot of the impedance data and the processed fitting data.

FIGS. 8A-8B show representative impedance data and impedance simulation results for a representative disclosed ALD-coated cell (Cell No. 2, Table 1) at 0 h and 750° C. FIG. 8A shows impedance data and individual RQ contribution plots and their sum with the equivalent circuit model (schematically shown above the plot) used for simulation. FIG. 8B shows a Nyquist plot of the impedance data and the processed fitting data.

FIGS. 9A-9B show representative impedance data and impedance simulation results for a representative disclosed ALD-coated cell (Cell No. 2, Table 1) at 96 h and 750° C. FIG. 9A shows impedance data and individual RQ contribution plots and their sum with the equivalent circuit model (schematically shown above the plot) used for simulation. FIG. 9B shows a Nyquist plot of the impedance data and the processed fitting data.

FIGS. 10A-10B show representative impedance data and impedance simulation results for a representative disclosed ALD-coated cell (Cell No. 2, Table 1) at 168 h and 750° C. FIG. 10A shows impedance data and individual RQ contribution plots and their sum with the equivalent circuit model (schematically shown above the plot) used for simulation. FIG. 10B shows a Nyquist plot of the impedance data and the processed fitting data.

FIGS. 11A-11B show representative impedance data and impedance simulation results for a representative disclosed ALD-coated cell (Cell No. 2, Table 1) at 336 h and 750° C. FIG. 11A shows impedance data and individual RQ contribution plots and their sum with the equivalent circuit model (schematically shown above the plot) used for simulation. FIG. 11B shows a Nyquist plot of the impedance data and the processed fitting data.

FIGS. 12A-12B show representative impedance data and impedance simulation results for a representative disclosed ALD-coated cell (Cell No. 2, Table 1) at 502 h and 750° C. FIG. 12A shows impedance data and individual RQ contribution plots and their sum with the equivalent circuit model (schematically shown above the plot) used for simulation. FIG. 12B shows a Nyquist plot of the impedance data and the processed fitting data.

FIGS. 13A-13B show representative impedance data and impedance simulation results for a baseline cell (Cell No. 3, Table 1) at 0 h and 650° C. FIG. 13A shows impedance data and individual RQ contribution plots and their sum with the equivalent circuit model (schematically shown above the plot) used for simulation. FIG. 13B shows a Nyquist plot of the impedance data and the processed fitting data.

FIGS. 14A-14B show representative impedance data and impedance simulation results for a representative disclosed ALD-coated cell (Cell No. 4, Table 1) at 0 h and 650° C. FIG. 14A shows impedance data and individual RQ contribution plots and their sum with the equivalent circuit model (schematically shown above the plot) used for simulation. FIG. 14B shows a Nyquist plot of the impedance data and the processed fitting data.

FIGS. 15A-15B show representative impedance data and impedance simulation results for a representative disclosed ALD-coated cell (Cell No. 4, Table 1) at 24 h and 650° C. FIG. 15A shows impedance data and individual RQ contribution plots and their sum with the equivalent circuit model (schematically shown above the plot) used for simulation. FIG. 15B shows a Nyquist plot of the impedance data and the processed fitting data.

FIGS. 16A-16B show representative impedance data and impedance simulation results for a representative disclosed ALD-coated cell (Cell No. 4, Table 1) at 96 h and 650° C. FIG. 16A shows impedance data and individual RQ contribution plots and their sum with the equivalent circuit model (schematically shown above the plot) used for simulation. FIG. 16B shows a Nyquist plot of the impedance data and the processed fitting data.

FIGS. 17A-17B show representative impedance data and impedance simulation results for a representative disclosed ALD-coated cell (Cell No. 4, Table 1) at 648 h and 650° C. FIG. 17A shows impedance data and individual RQ contribution plots and their sum with the equivalent circuit model (schematically shown above the plot) used for simulation. FIG. 17B shows a Nyquist plot of the impedance data and the processed fitting data.

FIGS. 18A-18B show representative impedance data and impedance simulation results for a representative disclosed ALD-coated cell (Cell No. 4, Table 1) at 816 h and 650° C. FIG. 18A shows impedance data and individual RQ contribution plots and their sum with the equivalent circuit model (schematically shown above the plot) used for simulation. FIG. 18B shows a Nyquist plot of the impedance data and the processed fitting data.

Additional advantages of the disclosure will be set forth in part in the description which follows, and in part will be obvious from the description or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an ALD-coated cell,” “a nanocomposite,” or “a nanoparticle,” includes, but is not limited to, two or more such ALD-coated cells, nanocomposites, or nanoparticles, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a nanocomposite layer refers to a nanocomposite layer that is sufficiently thick to achieve the desired improvement in the property modulated by the nanocomposite layer, e.g., conductivity and/or stability of the cell. The specific level in terms of thickness (nm) required as an effective amount will depend upon a variety of factors composition of the cathode, temperature parameters for use, and the like.

As used herein, “LSCF” refers to a mixed conductor material that comprises lanthanum strontium cobalt ferrite composite oxide. Electrodes, e.g., a cathode, as disclosed herein can comprise LSCF. The LSCF can have the following formula:

La₁₋ₘSrₘCoₙFe₁₋ₙO_{3-δ},

where n is in the range of 0.4≤n≤0.6 In the foregoing formula, m can be in the range of 0≤m≤0.5, or in particular aspects, about 0.4. In the foregoing, δ oxygen deficiency and δ can vary in the range of 0 or more and 0.5 or less depending on the mole ratio of Sr (that is, m), the mole ratio of Co (that is, n), and the oxidation numbers of Co and Fe. The the ratio of the number of moles of Co to the sum of the number of moles of Co and the number of moles of Fe can be 0.4 or more and 0.6 or less. In some instances, the lanthanum strontium cobalt ferrite composite oxide has the following formula: La_{0.6}Sr_{0.4}Fe_{0.8}Co_{0.2}O₃.

As used herein, “LSM” refers to a mixed conductor material that comprises lanthanum strontium manganite composite oxide. Electrodes, e.g., a cathode, as disclosed herein can comprise LSM. The LSM can have the following formula:

La₁₋ₘSrₘMnₙO_{3±δ}.

In some instances, the foregoing formula has the particular formulation of: La₁₋ₘSrₘMnO₃. In other instances, the foregoing formula has the particular formulation of: La_{0.8}Sr_{0.2}MnO₃.

As used herein, “[100] direction of LSCF” refers to the [100] crystal orientation of the LSCF that has a rhombohedral crystal structure.

As used herein, “metal oxide nanograins” refers to any grain of material comprising a metal oxide composition having an average grain size on the scale of nanometers, and in various respects, having a diameter less than 1000 nm or less than 100 nm. In various respects, “nanograin” refers to materials and structures sized between about 1 nm to about 1000 nm in at least one dimension, e.g., diameter. Typically the term “nanograin” is used to describe the microstructure of a final densified body made from nanocrystalline metal powders via the described methods, e.g., atomic layer deposition. Nanograin is a crystallite of nanoscale size, which is a building block for polycrystalline material. Nanograin is a monocrystalline element (building block) of a polycrystalline structure, connected with the other nanograins through the grain boundaries (heterojunctions and homojunctions).

As used herein, “solid oxide fuel cell” or “SOFC” refers to an electrochemical conversion device that produces electricity by oxidizing a fuel. Generally speaking, an SOFC operates as follows: reduction of oxygen molecules into oxygen ions occurs at a cathode; an electrolyte material conducts the negative oxygen ions from the cathode to an anode, where electrochemical oxidation of oxygen ions with hydrogen or carbon monoxide occurs; the electrons then flow through an external circuit and re-enter the cathode.

As used herein, “electrode” includes electric conducting structures (including cathode and/or anode) suitable for electrochemical energy conversion devices, including solid oxide fuel cell (SOFC) and solid oxide electrolyzer cell (SOEC) as well as a protonic conductor.

As used herein, “conformal coating” refers to a coating or layer which matches or follows the topography of the underlying substrate.

As used herein, the terms “optional” or “optionally” means that the subsequently described event or circumstance can or cannot occur, and that the description includes instances where the event or circumstance occurs and instances where it does not.

Unless otherwise specified, temperatures referred to herein are based on atmospheric pressure (i.e., one atmosphere).

The following abbreviations are used herein throughout and can be used interchangeably with the corresponding text phrase.

| Abbreviation | Meaning |
|---|---|
| ALD | Atomic layer deposition |
| HRTEM | High resolution transmission electron microscopy |
| LSCF | Lanthanum strontium cobalt ferrite |
| ORR | Oxygen reduction reaction |
| Rₛ | Ohmic resistance |
| Rₚ | Polarization resistance |
| SDC | Sm₂O₃-doped CeO₂ |
| SOC | Solid oxide cell |
| SOFC | Solid oxide fuel cell |
| TEM | Transmission electron microscopy |

### B. ALD-Coated Electrodes

In one aspect, the present disclosure pertains to coated electrodes. In a further aspect, the coated electrodes comprise: an electrode comprising a nanocomposite coating; wherein the nanocomposite coating comprises: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof; wherein the first coating layer is subjacent to the second coating layer; and wherein the second coating layer is superjacent to the first coating layer, thereby capping the first coating layer.

Also disclosed herein nanocomposite coatings, e.g., the nanocomposite coatings provided to an electrode, the nanocomposite coatings comprising: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof; wherein the first coating layer is subjacent to the second coating layer; and wherein the second coating layer is superjacent to the first coating layer, thereby capping the first coating layer.

As discussed above in the Background section, high resistance of the oxygen electrode still significantly hinders the state-of-the-art solid oxide fuel cells (SOFCs). For an oxygen electrode comprising mixed electrical and ionic conductors such as perovskite lanthanum strontium cobalt ferrite (LSCF), conventional oxygen electrodes deteriorate due to its low chemical stability and cation surface segregation. The disclosed ALD-coated cells prevent the cation surface segregation and its resultant perovskite phase decomposition. As disclosed herein, the disclosed ALD coating can provide a conformal ultra-thin (5-20 nm) surface heterogeneous coating layer comprising subjacent discrete Pt nanoparticles capped with a superjacent fully dense conformal CoOₓ layer. Data obtained in the performance studies in the Examples herein below indicate that the disclosed ALD coating reduces the cell series resistance by up to 40%. The disclosed ALD coating layer possesses extraordinary nanostructure stability, presenting an intact morphology comparable to the initial as-deposited state even after operation up to 816 h. The ALD coating comprises a conformal CoOₓ layer comprising randomly orientated single-layered nanograins, with high-density intergranular and surface grain boundaries serving as the electrochemical reaction sites and facilitating mass transport. The disclosed ALD coating layer suppresses the Sr outward diffusion and confined the Sr-enriched layer to a ˜2 nm interface perovskite phase between the coating layer and the LSCF grain surface. Moreover, this ultra-thin Sr-enriched perovskite layer possesses high oxygen vacancy and high ionic conductivity. It also imposes tensile strain to the LSCF grain surfaces. The disclosed ALD coating layer is estimated to have a conductivity of ˜1.27×10⁴ S/cm, which is greater than two orders magnitude improvement to uncoated LSCF.

In a further aspect, the nanocomposite coating is conformal with the underlying electrode surface and the layered coating of the coating has a nanometer scale thickness. In a further aspect, the layered coated has a total thickness of from about 1 nm to about 200 nm; a total thickness of from about 1 nm to about 100 nm; a total thickness of from about 1 nm to about 80 nm; a total thickness of from about 1 nm to about 60 nm; a total thickness of from about 1 nm to about 40 nm; a total thickness of from about 1 nm to about 20 nm; a total thickness of from about 2 nm to about 100 nm; a total thickness of from about 2 nm to about 80 nm; a total thickness of from about 2 nm to about 60 nm; a total thickness of from about 2 nm to about 40 nm; a total thickness of from about 2 nm to about 20 nm; a total thickness of from about 2 nm to about 15 nm; a total thickness of from about 2 nm to about 10 nm; a total thickness of from about 5 nm to about 15 nm; or a total thickness of from about 5 nm to about 20 nm.

In a further aspect, the layered coating comprises a subjacent discrete nano-metal capped with a superjacent conformal layer, e.g., such that the subjacent discrete layer comprises nano-Pt, nano-Ag, nano-Au, or combinations thereof and the superjacent conformal layer comprises metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations.

In a further aspect, the electrode can be a suitable electrode, e.g., a cathode, as used in various types of SOCs. In a still further aspect, the electrode can comprise lanthanum strontium cobalt ferrite (LSCF). In a yet further aspect, the electrode can comprise a LSCF/SDC composite electrode.

In a further aspect, the coated electrode, e.g., a LSCF/SDC composite electrode, when used in an SOC cell series can reduce cell series resistance by at least 5%, by at least 10%, by at least 15%, by at least 20%, by at least 25%, by at least 30%, by at least 35%, by at least 40%, or a range comprising as lower and upper bounds any two values from the foregoing list, or a set of values from the foregoing list. The reduction in the foregoing is a comparative measurement comparing the resistance of SOC series resistance comprising an SOC comprising a disclosed coated electrode compared to substantially the same SOC comprising an uncoated electrode of the same type as the coated electrode but lacking the disclosed coating.

In a further aspect, a cell comprising the a coated exhibits substantially intact morphology of the coating layer after 100 h of operation, after 150 h of operation, after 200 h of operation, after 250 h of operation, after 300 h of operation, after 350 h of operation, after 400 h of operation, after 450 h of operation, after 500 h of operation, after 550 h of operation, after 600 h of operation, after 650 h of operation, after 700 h of operation, after 750 h of operation, after 800 h of operation, or a range comprising as lower and upper bounds any two values from the foregoing list, or a set of values from the foregoing list.

In a further aspect, the superjacent oxide layer, e.g., CoOₓ, comprises randomly orientated but single-layered nanograins, with high-density intergranular and surface grain boundaries serving as the electrochemical reaction sites and facilitating mass transport.

The disclosed coated electrode transforms an electrode—compared to an uncoated electrode—from an original perovskite surface that is vulnerable to cation segregation and degradation into the disclosed coated electrode comprising an embedded strained interface phase with enormous conductivity. Without wishing to be bound by a particular theory, the coating layer is believed to suppress Sr outward diffusion. Data discussed herein below shows that the coating layer confines a 2 nm Sr-enriched interface layer between the coating layer and the LSCF backbone. The conductivity of the coating layer is estimated to be about 1.27×10⁴ S/cm and two orders magnitude higher than that of LSCF.

The methods disclosed herein can be used to provide the disclosed nanocomposite coating to electrodes of solid oxide cells, including both solid oxide fuel cells (for electricity generation) and solid oxide electrolysis cells (for hydrogen or oxygen production).

### C. SOC Cells Comprising the Disclosed Coated Electrodes

In one aspect, the disclosure relates to SOC cells comprising the disclosed coated electrodes, e.g., electrodes comprising a conformal ultra-thin nanocomposite comprising Pt and CoOₓ on a LSCF/SDC cathode backbone. In a further aspect, the SOC cells comprising the disclosed coated electrodes, e.g., an ultra-thin nanocomposite comprising Pt and CoOₓ on a LSCF/SDC cathode backbone, are prepared using a disclosed Atomic Layer Deposition (ALD) coating method as disclosed herein. In a still further aspect, the disclosed SOC cells comprise an electrode having a heterogeneous coating layer comprising subjacent discrete Pt nanoparticles capped with superjacent fully dense conformal CoOₓ layer. In a yet further aspect, the performance of the disclosed ALD-coated cells is improved compared to baseline cells lacking the disclosed ALD coating on a LSCF/SDC cathod backbone.

### D. Methods of Preparing the Disclosed ALD-Coated Electrodes

In one aspect, the disclosure relates to a method of forming a multi-layer electrocatalyst nanostructure on an electrode using atomic layer deposition (ALD). More specifically, in one aspect, the disclosed method includes using ALD to deposit a first layer comprising a plurality of discrete nanoparticles of a first electrocatalyst on a surface of the electrode, and depositing one or more of a second layer comprising a second electrocatalyst superjacent the electrode and the first layer.

Generally speaking, atomic layer deposition is a subclass of chemical vapor deposition and encompasses a thin-film deposition technique based on the sequential use of a gas phase chemical process. During atomic layer deposition a film is grown on a substrate by exposing its surface to alternate gaseous species, typically referred to as precursors. The precursor molecules react with the surface in a self-limiting way, so that the reaction terminates once all the reactive sites on the surface are consumed. Consequently, the maximum amount of material deposited on the surface after a single exposure to all of the precursors (a so-called ALD cycle) is determined by the nature of the precursor-surface interaction. By varying the number of cycles it is possible to grow materials uniformly and with high precision on arbitrarily complex and large substrates. Through the repeated exposure to separate precursors, a thin film is slowly deposited on a target surface. The chemistry of any particular layer can be specified or modified by selecting the precursors, the oxidant, the processing temperature, the processing pressure, or a combination thereof, each of which can be automated and controlled with a control system. ALD is considered one deposition method with great potential for producing very thin, conformal films with control of the thickness and composition of the films possible at the atomic level.

According to various aspects, the ALD technique comprises introducing a precursor and an oxidant to the subjacent layer or surface and allowing the precursor to react with the subjacent layer or surface, forming a thin film layer thereon. The precursor can be selected from any suitable precursor that will provide the desired layer by ALD. Exemplary precursors include, for example: Cerium(III) trifluoroacetylacetonate hydrate; Tris(cyclopentadienyl)cerium(III); Tris(i-propylcyclopentadienyl)cerium(III); Bis(N-t-butyl-N′-ethylpropanimidamidato)cobalt(II); Bis(N,N′-di-i-propylacetamidinato)cobalt(II); Bis(1,4-di-t-butyl-1,3-diazabutadienyl)cobalt(II) Co(DAD)2; Bis(cyclopentadienyl)cobalt(II); Bis(N,N′-di-i-propylacetamidinato)cobalt(II); Tris(cyclopentadienyl)lanthanum; Tris(N, N′-di-i-propylformamidinato)lanthanum(III); Tris(i-propylcyclopentadienyl)lanthanum; Bis(ethylcyclopentadienyl)nickel; Bis(cyclopentadienyl)nickel; Bis(pentamethylcyclopentadienyl)nickel; Bis(i-propylcyclopentadienyl)nickel; Platinum(II) acetylacetonate; Platinum(II) hexafluoroacetylacetonate; (Trimethyl)cyclopentadienylplatinum(IV); (Trimethyl)methylcyclopentadienylplatinum(IV); Praseodymium(III) hexafluoroacetylacetonate; Tris(cyclopentadienyl)praseodymium; or Tris(i-propylcyclopentadienyl)praseodymium. The oxidant can be selected from any suitable oxidant that will provide the desired electrocatalyst layer. Exemplary oxidants include hydrogen peroxide (H₂O₂), Water (H₂O), Oxygen (O₂) and Ozone (O₃).

In one aspect, the disclosed method involves depositing a first layer of Pt catalyst on a target surface of an electrode, wherein the first layer of Pt catalyst comprises a plurality of particles (or grains) having a first particle (or grain) size. The method further comprises depositing one or more of a second layer of a second electrocatalyst superjacent the first Pt layer and the surface of the electrode, to provide one or more second layers having second thickness. In various aspects, the target surface of the electrode may be an internal surface, an external surface, or both. In various aspects, the first layer can provide coverage of the substrate area to the extent of about 5%, 10%, 15%, 20%, 25%, 30%, 35%, 40%, 45%, 50%, 55%, 60%, 65%, 70%, 75%, 80%, 85%, 90%, 95%, 100%, or range of substrate area coverage with an lower and upper limit comprising any of the foregoing values, or a set of values selected from any of the foregoing values. In some aspects, the first layer coverage can be any amount such that a nano-grained network is formed with grain boundaries acting as pathway for oxygen diffusion. There may be some advantage to higher levels of substrate coverage, but this would be balanced against cost (greater amounts of catalyst in the first layer utilized) and benefit (whether the increase in performance were justified by the layer costs) considerations.

### E. References

References are cited herein throughout using the format of reference number(s) enclosed by parentheses corresponding to one or more of the following numbered references. For example, citation of references numbers 1 and 2 immediately herein below would be indicated in the disclosure as (Refs. 1-2).
Ref 1. Hauch, A.; Kungas, R.; Blennow, P.; Hansen, A. B.; Hansen, J. B.; Mathiesen, B. V.; Mogensen, M. B., Recent advances in solid oxide cell technology for electrolysis. Science 2020, 370 (6513), eaba6118.
Ref 2. Jiang, S. P., Development of lanthanum strontium cobalt ferrite perovskite electrodes of solid oxide fuel cells—A review. International Journal of Hydrogen Energy 2019, 44 (14), 7448-7493.
Ref 3. Okamoto, H.; Kawamura, G.; Kudo, T., Study of oxygen adsorption on platinum through observation of exchange current in a solid electrolyte concentration cell. Electrochimica Acta 1983, 28 (3), 379-382.
Ref 4. Hu, H.; Liu, M., Interfacial Polarization Characteristics of Pt|BaCe0.8Gd0.2O3|Pt Cells at Intermediate Temperatures. Journal of The Electrochemical Society 1997, 144 (10), 3561-3567.
Ref 5. Schouler, E.; Giroud, G.; Kleitz, M., Applications selon Bauerle du tracé des diagrammes d′admittance complexe en électrochimie des solides*. J. Chim. Phys. 1973, 70, 1309-1316.
Ref 6. Verkerk, M. J.; Hammink, M. W. J.; Burggraaf, A. J., Oxygen Transfer on Substituted ZrO2, Bi2O3, and CeO2 Electrolytes with Platinum Electrodes: I. Electrode Resistance by D-C Polarization. Journal of The Electrochemical Society 1983, 130 (1), 70-78.
Ref 7. Lewis, R.; Gomer, R., Adsorption of oxygen on platinum. Surface Science 1968, 12 (2), 157-176.
Ref 8. Mizusaki, J.; Amano, K.; Yamauchi, S.; Fueki, K., Electrode reaction at Pt, O2(g)/stabilized zirconia interfaces. Part I: Theoretical consideration of reaction model. Solid State Ionics 1987, 22 (4), 313-322.
Ref 9. Ding, D.; Li, X.; Lai, S. Y.; Gerdes, K.; Liu, M., Enhancing SOFC cathode performance by surface modification through infiltration. Energy & Environmental Science 2014, 7 (2), 552-575.
Ref 10. Irvine, J. T. S.; Neagu, D.; Verbraeken, M. C.; Chatzichristodoulou, C.; Graves, C.; Mogensen, M. B., Evolution of the electrochemical interface in high-temperature fuel cells and electrolysers. Nature Energy 2016, 1 (1), 15014.
Ref 11. Maier, J., Thermodynamics of Nanosystems with a Special View to Charge Carriers. Advanced Materials 2009, 21 (25-26), 2571-2585.
Ref 12. Chadwick, A. V., Transport in defective ionic materials: from bulk to nanocrystals. physica status solidi (a) 2007, 204 (3), 631-641.
Ref 13. Sonn, V.; Leonide, A.; Ivers-Tiffee, E., Combined Deconvolution and CNLS Fitting Approach Applied on the Impedance Response of Technical Ni8YSZ Cermet Electrodes. Journal of The Electrochemical Society 2008, 155 (7), B675.
Ref 14. Liu, B.; Muroyama, H.; Matsui, T.; Tomida, K.; Kabata, T.; Eguchi, K., Analysis of Impedance Spectra for Segmented-in-Series Tubular Solid Oxide Fuel Cells. Journal of The Electrochemical Society 2010, 157 (12), B1858.
Ref 15. Barfod, R.; Mogensen, M.; Klemensd, T.; Hagen, A.; Liu, Y.-L.; Vang Hendriksen, P., Detailed Characterization of Anode-Supported SOFCs by Impedance Spectroscopy. Journal of The Electrochemical Society 2007, 154 (4), B371.
Ref 16. Leonide, A.; Ruger, B.; Weber, A.; Meulenberg, W. A.; Ivers-Tiffée, E., Impedance Study of Alternative (La, Sr)FeO3-δ and (La,Sr)(Co,Fe)O3-δ MIEC Cathode Compositions. Journal of The Electrochemical Society 2010, 157 (2), B234.
Ref 17. Kornely, M.; Neumann, A.; Menzler, N. H.; Leonide, A.; Weber, A.; Ivers-Tiffée, E., Degradation of anode supported cell (ASC) performance by Cr-poisoning. Journal of Power Sources 2011, 196 (17), 7203-7208.
Ref 18. Leonide, A.; Sonn, V.; Weber, A.; Ivers-Tiffee, E., Evaluation and Modeling of the Cell Resistance in Anode-Supported Solid Oxide Fuel Cells. Journal of The Electrochemical Society 2008, 155 (1), B36.
Ref 19. Chen, Y.; Choi, Y.; Yoo, S.; Ding, Y.; Yan, R.; Pei, K.; Qu, C.; Zhang, L.; Chang, I.; Zhao, B.; Zhang, Y.; Chen, H.; Chen, Y.; Yang, C.; deGlee, B.; Murphy, R.; Liu, J.; Liu, M., A Highly Efficient Multi-phase Catalyst Dramatically Enhances the Rate of Oxygen Reduction. Joule 2018, 2 (5), 938-949.
Ref 20. Adler, S. B., Factors Governing Oxygen Reduction in Solid Oxide Fuel Cell Cathodes. Chemical Reviews 2004, 104 (10), 4791-4844.
Ref 21. Yokokawa, H.; Horita, T.; Sakai, N.; Yamaji, K.; Brito, M. E.; Xiong, Y. P.; Kishimoto, H., Thermodynamic considerations on Cr poisoning in SOFC cathodes. Solid State Ionics 2006, 177 (35), 3193-3198.
Ref 22. S. P. Jiang, X. Chen, International Journal of Hydrogen Energy, 39 (2014) 505-531.
Ref 23. Chen, Y.; Fan, Y.; Lee, S.; Hackett, G.; Abernathy, H.; Gerdes, K.; Song, X., Interface and grain boundary degradation in LSM-YSZ composite Solid Oxide Fuel Cell cathodes operated in humidified air. Journal of Power Sources 2019, 438, 227043.
Ref 24. Yun Chen, Sergio A. Paredes-Navia; Cesar-Octavio Romo-De-La-Cruz.; Liang Liang; Andre Fernandes; Alec Hinerman, Xueyan Song Conformal Surface Film Utterly Shifting Oxygen Reduction Reaction Pathways And Increasing the Conductivity In Solid Oxide Fuel Cell, J. Power Sources, (Under review), 2020.
Ref 25. Maier, J., Nano-Ionics: More Than Just a Fashionable Slogan. Journal of Electroceramics 2004, 13 (1), 593-598.
Ref 26. Rupp, J. L. M.; Infortuna, A.; Gauckler, L. J., Microstrain and self-limited grain growth in nanocrystalline ceria ceramics. Acta Materialia 2006, 54 (7), 1721-1730.
Ref 27. Matsumoto, H.; Furuya, Y.; Okada, S.; Tanji, T.; Ishihara, T., Nanoionics phenomenon in proton-conducting oxide: Effect of dispersion of nanosize platinum particles on electrical conduction properties. Science and Technology of Advanced Materials 2007, 8 (6), 531-535.
Ref 28. Tomov, R. I.; Mitchel-Williams, T. B.; Maher, R.; Kerherve, G.; Cohen, L.; Payne, D. J.; Kumar, R. V.; Glowacki, B. A., The synergistic effect of cobalt oxide and Gd—CeO2 dual infiltration in LSCF/CGO cathodes. Journal of Materials Chemistry A 2018, 6 (12), 5071-5081.
Ref 29. Lee, W.; Jung, H. J.; Lee, M. H.; Kim, Y.-B.; Park, J. S.; Sinclair, R.; Prinz, F. B., Oxygen Surface Exchange at Grain Boundaries of Oxide Ion Conductors. Advanced Functional Materials 2012, 22 (5), 965-971.
Ref 30. Saranya, A. M.; Pla, D.; Morata, A.; Cavallaro, A.; Canales-Vázquez, J.; Kilner, J. A.; Burriel, M.; Tarancón, A., Engineering Mixed lonic Electronic Conduction in La0.8Sr0.2MnO3+δ Nanostructures through Fast Grain Boundary Oxygen Diffusivity. Advanced Energy Materials 2015, 5 (11), 1500377.
Ref 31. Lee, K. T.; Wachsman, E. D., Role of nanostructures on SOFC performance at reduced temperatures. MRS Bulletin 2014, 39 (9), 783-791.
Ref 32. Navickas, E.; Huber, T. M.; Chen, Y.; Hetaba, W.; Holzlechner, G.; Rupp, G.; Stöger-Pollach, M.; Friedbacher, G.; Hutter, H.; Yildiz, B.; Fleig, J., Fast oxygen exchange and diffusion kinetics of grain boundaries in Sr-doped LaMnO3 thin films. Physical Chemistry Chemical Physics 2015, 17 (12), 7659-7669.
Ref 33. Polfus, J. M.; Yildiz, B.; Tuller, H. L., Origin of fast oxide ion diffusion along grain boundaries in Sr-doped LaMnO3. Physical Chemistry Chemical Physics 2018, 20 (28), 19142-19150.
Ref 34. Chiabrera, F.; Garbayo, I.; Tarancón, A., 17—Nanoionics and interfaces for energy and information technologies. In Metal Oxide-Based Thin Film Structures, Pryds, N.; Esposito, V., Eds. Elsevier: 2018; pp 409-439.
Ref 35. Chiabrera, F.; Morata, A.; Pacios, M.; Tarancón, A., Insights into the enhancement of oxygen mass transport properties of strontium-doped lanthanum manganite interface-dominated thin films. Solid State Ionics 2017, 299, 70-77.
Ref 36. Develos-Bagarinao, K.; Kishimoto, H.; De Vero, J.; Yamaji, K.; Horita, T., Effect of La0.6Sr0.4Co0.2Fe0.8O3-δ microstructure on oxygen surface exchange kinetics. Solid State Ionics 2016, 288, 6-9.
Ref 37. Develos-Bagarinao, K.; Kishimoto, H.; Ishiyama, T.; Horita, T.; Yokokawa, H.; Yamaji, K., (Invited) Probing Oxide lon Transport in Fluorite and Perovskite Oxides for Solid Oxide Fuel Cells. ECS Transactions 2016, 72 (7), 139-148.
Ref 38. Chen, Y.; Gerdes, K.; Paredes Navia, S. A.; Liang, L.; Hinerman, A.; Song, X., Conformal Electrocatalytic Surface Nanoionics for Accelerating High-Temperature Electrochemical Reactions in Solid Oxide Fuel Cells. Nano Letters 2019, 19 (12), 8767-8773.
Ref 39. Prado, F.; Armstrong, T.; Caneiro, A.; Manthiram, A., Structural Stability and Oxygen Permeation Properties of Sr3-xLaxFe2-yCoyO7-δ (0≤x≤0.3 and 0δ≤y≤1.0). Journal of The Electrochemical Society 2001, 148 (4), J7.
Ref 40. Sowjanya, C.; Mandal, R.; Abhinay, S.; Mohanta, A.; Das, S.; Pratihar, S. K., Effect of B-site substitution on the crystal structure, electrical conductivity and oxygen transport properties of La0.5Sr0.5M0.2Fe0.8O3-δ (M=Co, Al, and Zn) perovskite. Journal of Solid State Chemistry 2020, 285, 121237.
Ref 41. Garcia-Barriocanal, J.; Rivera-Calzada, A.; Varela, M.; Sefrioui, Z.; Iborra, E.; Leon, C.; Pennycook, S. J.; Santamaria, J., Colossal lonic Conductivity at Interfaces of Epitaxial ZrO2:Y2O3/SrTiO3 Heterostructures. Science 2008, 321 (5889), 676.
Ref 42. Kushima, A.; Yildiz, B., Oxygen ion diffusivity in strained yttria stabilized zirconia: where is the fastest strain? Journal of Materials Chemistry 2010, 20 (23), 4809-4819.
Ref 43. MacManus-Driscoll, J. L.; Zerrer, P.; Wang, H.; Yang, H.; Yoon, J.; Fouchet, A.; Yu, R.; Blamire, M. G.; Jia, Q., Strain control and spontaneous phase ordering in vertical nanocomposite heteroepitaxial thin films. Nature Materials 2008, 7 (4), 314-320.
Ref 44. Petrie, J. R.; Mitra, C.; Jeen, H.; Choi, W. S.; Meyer, T. L.; Reboredo, F. A.; Freeland, J. W.; Eres, G.; Lee, H. N., Strain Control of Oxygen Vacancies in Epitaxial Strontium Cobaltite Films. Advanced Functional Materials 2016, 26 (10), 1564-1570.
Ref 45. Lee, D.; Grimaud, A.; Crumlin, E. J.; Mezghani, K.; Habib, M. A.; Feng, Z.; Hong, W. T.; Biegalski, M. D.; Christen, H. M.; Shao-Horn, Y., Strain Influence on the Oxygen Electrocatalysis of the (100)-Oriented Epitaxial La2NiO4+δ Thin Films at Elevated Temperatures. The Journal of Physical Chemistry C 2013, 117 (37), 18789-18795.
Ref 46. Stoerzinger, K. A.; Choi, W. S.; Jeen, H.; Lee, H. N.; Shao-Horn, Y., Role of Strain and Conductivity in Oxygen Electrocatalysis on LaCoO3 Thin Films. The Journal of Physical Chemistry Letters 2015, 6 (3), 487-492.
Ref 47. Petrie, J. R.; Jeen, H.; Barron, S. C.; Meyer, T. L.; Lee, H. N., Enhancing Perovskite Electrocatalysis through Strain Tuning of the Oxygen Deficiency. Journal of the American Chemical Society 2016, 138 (23), 7252-7255.
Ref 48. Finklea, H.; Chen, X.; Gerdes, K.; Pakalapati, S.; Celik, I. Analysis of SOFCs using reference electrodes. Journal of The Electrochemical Society 2013, 160 (9), F1055-F1066.
Ref 49. Schichlein, H.; Muller, A. C.; Voigts, M.; Krugel, A.; Ivers-Tiffee, E. Deconvolution of electrochemical impedance spectra for the identification of electrode reaction mechanisms in solid oxide fuel cells. J. Appl. Electrochem. 2002, 32 (8), 875-882
Ref 50. Escudero M, Aguadero A, Alonso J A, Daza L. A kinetic study of oxygen reduction reaction on La2NiO4 cathodes by means of impedance spectroscopy. Journal of electroanalytical chemistry 2007, 611(1-2), 107-16.
Ref 51. Jørgensen MJ, Mogensen M. Impedance of solid oxide fuel cell LSM/YSZ composite cathodes. Journal of The Electrochemical Society 2001, 148(5), A433-A42.
Ref 52. Zhao K, Xu Q, Huang D-P, Chen M, Kim B-H. Microstructure and electrochemical properties of porous La 2 NiO 4+δ electrodes spin-coated on Ce 0.8 Sm 0.2 O 1.9 electrolyte. Ionics 2012, 18(1-2), 75-83.
Ref 53. Gore C M, White J O, Wachsman E D, Thangadurai V. Effect of composition and microstructure on electrical properties and CO 2 stability of donor-doped, proton conducting BaCe 1−(x+y) Zr x Nb y O 3. Journal of Materials Chemistry A 2014, 2(7), 2363-73

### F. Aspects

The following listing of exemplary aspects supports and is supported by the disclosure provided herein.
Aspect 1. A nanocomposite coating comprising: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof wherein the first coating layer is subjacent to the second coating layer; and wherein the second coating layer is superjacent to the first coating layer, thereby capping the first coating layer.
Aspect 2. The nanocomposite coating of Aspect 1, wherein the layered coating has a total thickness of from about 1 nm to about 200 nm.
Aspect 3. The nanocomposite coating of Aspect 2, wherein the layered coating has a total thickness of from about 1 nm to about 100 nm.
Aspect 4. The nanocomposite coating of Aspect 2, wherein the layered coating has a total thickness of from about 1 nm to about 80 nm.
Aspect 5. The nanocomposite coating of Aspect 2, wherein the layered coating has a total thickness of from about 1 nm to about 60 nm.
Aspect 6. The nanocomposite coating of Aspect 2, wherein the layered coating has a total thickness of from about 1 nm to about 40 nm.
Aspect 7. The nanocomposite coating of Aspect 2, wherein the layered coating has a total thickness of from about 1 nm to about 20 nm.
Aspect 8. The nanocomposite coating of Aspect 2, wherein the layered coating has a total thickness of from about 2 nm to about 100 nm.
Aspect 9. The nanocomposite coating of Aspect 2, wherein the layered coating has a total thickness of from about 2 nm to about 80 nm.
Aspect 10. The nanocomposite coating of Aspect 2, wherein the layered coating has a total thickness of from about 2 nm to about 60 nm.
Aspect 11. The nanocomposite coating of Aspect 2, wherein the layered coating has a total thickness of from about 2 nm to about 40 nm.
Aspect 12. The nanocomposite coating of Aspect 2, wherein the layered coating has a total thickness of from about 2 nm to about 20 nm.
Aspect 13. The nanocomposite coating of Aspect 2, wherein the layered coating has a total thickness of from about 2 nm to about 15 nm.
Aspect 14. The nanocomposite coating of Aspect 2, wherein the layered coating has a total thickness of from about 2 nm to about 10 nm.
Aspect 15. The nanocomposite coating of Aspect 2, wherein the layered coating has a total thickness of from about 5 nm to about 15 nm.
Aspect 16. The nanocomposite coating of Aspect 2, wherein the layered coating has a total thickness of from about 5 nm to about 20 nm.
Aspect 17. The nanocomposite coating of any one of Aspect 1-Aspect 16, wherein the continuous conformal layer comprises metal oxide nanograins distributed as a single-layer.
Aspect 18. The nanocomposite coating of any one of Aspect 1-Aspect 17, wherein the discrete nanoparticles are elongated discrete nanoparticles.
Aspect 19. The nanocomposite coating of Aspect 18, wherein the elongated discrete nanoparticles are from about 1 nm to about 100 nm in their longest dimension.
Aspect 20. The nanocomposite coating of any one of Aspect 1-Aspect 19, wherein the metal oxide nanograins are elongated metal oxide nanograins.
Aspect 21. The nanocomposite coating of Aspect 20, wherein the elongated metal oxide nanograins are from about 1 nm to about 200 nm in their longest dimension.
Aspect 22. The nanocomposite coating of Aspect 21, wherein the metal oxide nanograins are separated from one another by from about 1 nm to about 100 nm.
Aspect 23. The nanocomposite coating of Aspect 21, wherein the metal oxide nanograins are separated from one another by from about 1 nm to about 20 nm.
Aspect 24. The nanocomposite coating of Aspect 21, wherein the metal oxide nanograins are separated from one another by from about 2 nm to about 20 nm.
Aspect 25. The nanocomposite coating of Aspect 21, wherein the metal oxide nanograins are separated from one another by from about 5 nm to about 20 nm.
Aspect 26. The nanocomposite coating of Aspect 21, wherein the metal oxide nanograins are separated from one another by from about 10 nm to about 20 nm.
Aspect 27. The nanocomposite coating of Aspect 21, wherein the metal oxide nanograins are separated from one another by from about 15 nm to about 20 nm.
Aspect 28. The nanocomposite coating of Aspect 21, wherein the metal oxide nanograins are separated from one another by from about 10 nm to about 15 nm.
Aspect 29. The nanocomposite coating of Aspect 21, wherein the metal oxide nanograins are separated from one another by from about 5 nm to about 25 nm.
Aspect 30. The nanocomposite coating of Aspect 21, wherein the metal oxide nanograins are separated from one another by from about 10 nm to about 25 nm.
Aspect 31. The nanocomposite coating of any one of Aspect 1-Aspect 30, wherein the metal oxide nanograins are separated from one another by from about 1 nm to about 200 nm.
Aspect 32. The nanocomposite coating of any one of Aspect 1-Aspect 30, wherein the metal oxide nanograins are separated from one another by from about 0.001 nm to about 1 nm.
Aspect 33. The nanocomposite coating of any one of Aspect 1-Aspect 30, wherein the metal oxide nanograins are in contact with one another via intergrain boundaries.
Aspect 34. The nanocomposite coating of any one of Aspect 1-Aspect 33, wherein the layered coating is an atomic layer deposition (ALD) coating.
Aspect 35. The nanocomposite coating of any one of Aspect 1-Aspect 34, wherein the metal oxide nanograins comprise mixed valence metal oxide nanograins.
Aspect 36. The nanocomposite coating of Aspect 35, wherein the mixed valence metal oxide nanograins comprise at least two of Ce_{y}Oₓ; Co_{y}Oₓ; or Pr_{y}Oₓ.
Aspect 37. The nanocomposite coating of Aspect 35, wherein the mixed valence metal oxide nanograins comprise Co_{y}Oₓ.
Aspect 38. The nanocomposite coating of Aspect 37, wherein x has a value of from about 0.1 to about 10.
Aspect 39. The nanocomposite coating of Aspect 37 or Aspect 38, wherein y has a value from about 0.1 to about 2.
Aspect 40. The nanocomposite coating of Aspect 37 or Aspect 38, wherein y has a value that is greater than or equal to about 2.
Aspect 41. The nanocomposite coating of Aspect 37, wherein the Co_{y}Oₓ comprises CoO, CoO2, Co3O4, or combinations thereof.
Aspect 42. The nanocomposite coating of Aspect 35, wherein the mixed valence metal oxide nanograins comprise Ce_{y}Oₓ.
Aspect 43. The nanocomposite coating of Aspect 42, wherein x has a value of from about 0.1 to about 10.
Aspect 44. The nanocomposite coating of Aspect 42 or Aspect 43, wherein y has a value from about 0.1 to about 2.
Aspect 45. The nanocomposite coating of Aspect 42 or Aspect 43, wherein y has a value that is greater than or equal to about 2.
Aspect 46. The nanocomposite coating of Aspect 42, wherein the Ce_{y}Oₓ comprises Ce3O4, CeO2, or a combination thereof.
Aspect 47. The nanocomposite of Aspect 35, wherein the mixed valence metal oxide nanograins comprise Pr_{y}Oₓ.
Aspect 48. The nanocomposite coating of Aspect 47, wherein x has a value of from about 0.1 to about 10.
Aspect 49. The nanocomposite coating of Aspect 47 or Aspect 48, wherein y has a value from about 0.1 to about 2.
Aspect 50. The nanocomposite coating of Aspect 47 or Aspect 48, wherein y has a value that is greater than or equal to about 2.
Aspect 51. The nanocomposite coating of Aspect 47, wherein the Pr_{y}Oₓ comprises Pr₆O₁₁, Pr₁₁O₂₀, Pr₅O₉, or combinations thereof.
Aspect 52. The nanocomposite coating of Aspect 35, wherein the mixed valence metal oxide nanograins comprise La_{y}Ni_{z}Oₓ.
Aspect 53. The nanocomposite coating of Aspect 52, wherein x has a value of from about 0.1 to about 10.
Aspect 54. The nanocomposite coating of Aspect 52 or Aspect 53, wherein y has a value from about 0.1 to about 2.
Aspect 55. The nanocomposite coating of Aspect 52 or Aspect 53, wherein y has a value that is greater than or equal to about 2.
Aspect 56. The nanocomposite coating of any one of Aspect 52-Aspect 55, wherein z has a value from about 0.1 to about 2.
Aspect 57. The nanocomposite coating of any one of Aspect 52-Aspect 55, wherein z has a value that is greater than or equal to about 2.
Aspect 58. The nanocomposite coating of Aspect 52, wherein the La_{y}Ni_{z}Oₓ comprises La₂NiO₄, La₃Ni₂O₇, LaNiO₃, La₄Ni₃O₁₀, or combinations thereof.
Aspect 59. The nanocomposite coating of any one of Aspect 1-Aspect 58, wherein a doped metal oxide nanograin comprises a dopant selected from Ni, Fe, and a combination thereof.
Aspect 60. The nanocomposite coating of any one of Aspect 1-Aspect 58, wherein the second coating layer is essentially free from both Sr and La.
Aspect 61. An electrode comprising the nanocomposite coating of any one of Aspect 1-Aspect 60 on at least one surface of the electrode.
Aspect 62. The electrode of Aspect 61, wherein the electrode is cathode.
Aspect 63. The electrode of Aspect 61, wherein the electrode is a cobaltite-based perovskite electrode.
Aspect 64. The electrode of Aspect 63, wherein the cobaltite-based perovskite electrode comprises lanthanum strontium cobalt ferrite (LSCF).
Aspect 65. The electrode of Aspect 64, wherein the lanthanum strontium cobalt ferrite (LSCF) electrode is a carbonate-based lanthanum strontium cobalt-free Sm₂O₃-doped CeO2 (LSCF/SDC) cathode backbone.
Aspect 66. A product comprising the electrode of any one of Aspect 61-Aspect 65.
Aspect 67. The product of Aspect 66, wherein the product is a solid oxide cell (SOC).
Aspect 68. The product of Aspect 67, wherein the SOC is a solid oxide electrolysis cell (SOEC).
Aspect 69. The product of Aspect 67, wherein the SOC is a solid oxide fuel cell (SOFC).
Aspect 70. The product of Aspect 69, wherein the layered coating of the nanocomposite coating acts as a blocking layer to prevent segregation of contaminants in an SOFC system.
Aspect 71. The product of Aspect 69 or Aspect 70, wherein Cr deposition from Cr-containing interconnects occurs preferentially on a segregated SrO phase; and wherein the second coating layer of the layered coating comprising metal oxide nanograins is essentially free of Cr deposition from Cr-containing interconnects.
Aspect 72. The product of any one of Aspect 69-Aspect 71, wherein the solid oxide cell has a series resistance that is reduced by at least 10%.
Aspect 73. The product of Aspect 72, wherein the solid oxide cell has a series resistance that is reduced by at least 15%.
Aspect 74. The product of Aspect 72 wherein the solid oxide cell has a series resistance that is reduced by at least 20%.
Aspect 75. The product of Aspect 72, wherein the solid oxide cell has a series resistance that is reduced by at least 25%.
Aspect 76. The product of Aspect 72, wherein the solid oxide cell has a series resistance that is reduced by at least 30%.
Aspect 77. The product of Aspect 72, wherein the solid oxide cell has a series resistance that is reduced by at least 35%.
Aspect 78. The product of Aspect 72, wherein the solid oxide cell has a series resistance that is reduced by at least 40%.
Aspect 79. The product of Aspect 72, wherein the solid oxide cell has a series resistance that is reduced by at least 45%.
Aspect 80. The product of Aspect 72, wherein the solid oxide cell has a series resistance that is reduced by at least 50%.
Aspect 81. The product of any one of Aspect 69-Aspect 80, wherein the second coating layer of the layered coating comprising metal oxide nanograins separates Cr vapor from reaction with Sr cations.
Aspect 82. The product of any one of Aspect 69-Aspect 81, wherein the second coating layer of the layered coating comprising metal oxide nanograins prevents penetration of humidity into a cathode backbone, thereby decreasing performance degradation and increased durability and contamination tolerance of a cathode backbone.
Aspect 83. An article comprising a substrate with the nanocomposite coating of any one of Aspect 1-Aspect 60 on at least one surface of the substrate.
Aspect 84. The article of Aspect 83, wherein the substrate comprises an electrode.
Aspect 85. The article of Aspect 84, wherein the electrode is cathode.
Aspect 86. The article of Aspect 84, wherein the electrode is a cobaltite-based perovskite electrode.
Aspect 87. The article of Aspect 86, wherein the cobaltite-based perovskite electrode comprises lanthanum strontium cobalt ferrite (LSCF).
Aspect 88. The article of Aspect 87, wherein the lanthanum strontium cobalt ferrite (LSCF) electrode is a carbonate-based lanthanum strontium cobalt-free Sm₂O₃-doped CeO₂ (LSCF/SDC) cathode backbone.
Aspect 89. The article of any one of Aspect 87-Aspect 88, wherein the layered coating of the nanocomposite coating comprises Fe due to diffusion of LSCF from the cobaltite-based perovskite electrode.
Aspect 90. The article of any one of Aspect 87-Aspect 89, wherein the layered coating of the nanocomposite coating suppresses outward diffusion of Sr from the electrode.
Aspect 91. The article of Aspect 90, wherein the layered coating of the nanocomposite coating confines Sr to a Sr-enriched perovskite layer at a 2 nm interface of a perovskite phase between the layered coating and an LSCF grain surface.
Aspect 92. The article of Aspect 91, wherein the Sr-enriched perovskite layer possesses high oxygen vacancy and ionic conductivity in comparison with other interphase perovskite phases.
Aspect 93. The article of any one of Aspect 83-Aspect 92, wherein the layered coating of the nanocomposite coating exhibits higher Rp for both ORR and oxygen transport.
Aspect 94. The article of any one of Aspect 83-Aspect 93, wherein the layered coating of the nanocomposite coating provides an induced surface layer that possesses an estimated conductivity value of from about 1×10⁴ S/cm to about 3×10⁴ S/cm.
Aspect 95. A product comprising the article of any one of Aspect 83-Aspect 94.
Aspect 96. The product of Aspect 95, wherein the product is a solid oxide cell (SOC).
Aspect 97. The product of Aspect 96, wherein the SOC is a solid oxide electrolysis cell (SOEC).
Aspect 98. The product of Aspect 96, wherein the SOC is a solid oxide fuel cell (SOFC).
Aspect 99. The product of Aspect 98, wherein the layered coating of the nanocomposite coating acts as a blocking layer to prevent segregation of contaminants in an SOFC system.
Aspect 100. The product of Aspect 98 or Aspect 99, wherein Cr deposition from Cr-containing interconnects occurs preferentially on a segregated SrO phase; and wherein the second coating layer of the layered coating comprising metal oxide nanograins is essentially free of Cr deposition from Cr-containing interconnects.
Aspect 101. The product of any one of Aspect 96-Aspect 100, wherein the solid oxide cell has a series resistance that is reduced by at least 10%.
Aspect 102. The product of Aspect 101, wherein the solid oxide cell has a series resistance that is reduced by at least 15%.
Aspect 103. The product of Aspect 101, wherein the solid oxide cell has a series resistance that is reduced by at least 20%.
Aspect 104. The product of Aspect 101, wherein the solid oxide cell has a series resistance that is reduced by at least 25%.
Aspect 105. The product of Aspect 101, wherein the solid oxide cell has a series resistance that is reduced by at least 30%.
Aspect 106. The product of Aspect 101, wherein the solid oxide cell has a series resistance that is reduced by at least 35%.
Aspect 107. The product of Aspect 101, wherein the solid oxide cell has a series resistance that is reduced by at least 40%.
Aspect 108. The product of Aspect 101, wherein the solid oxide cell has a series resistance that is reduced by at least 45%.
Aspect 109. The product of Aspect 101, wherein the solid oxide cell has a series resistance that is reduced by at least 50%.
Aspect 110. The product of any one of Aspect 98-Aspect 109, wherein the second coating layer of the layered coating comprising metal oxide nanograins separates Cr vapor from reaction with Sr cations.
Aspect 111. The product of any one of Aspect 98-Aspect 110, wherein the second coating layer of the layered coating comprising metal oxide nanograins prevents penetration of humidity into a cathode backbone, thereby decreasing performance degradation and increased durability and contamination tolerance of a cathode backbone.
Aspect 112. A method of providing the nanocomposite coating of any one of Aspect 1-Aspect 60 on a substrate, the method comprising: providing a substrate an atomic layer deposition reaction chamber; performing at least one atomic layer deposition cycle to form a first coating layer on a surface of the substrate; wherein the first coating layer comprises discrete nanoparticles; wherein the discrete nanoparticles comprise Pt, Ag, Au, or combinations thereof; performing at least one atomic layer deposition cycle to form a second coating layer on the first coating layer; wherein the second coating layer comprises metal oxide nanograins; wherein the metal oxide nanograins comprise Co_{y}Oₓ; doped Co_{y}Oₓ; Pr_{y}Oₓ; doped Pr_{y}Oₓ; CeOₓ; doped CeOₓ; La_{y}Ni_{z}Oₓ; doped La_{y}Ni_{z}Oₓ; or combinations thereof; and wherein the second coating layer forms a continuous conformal layer comprising metal oxide nanograins on the first coating layer; wherein the first coating layer is subjacent to the second coating layer; and wherein the second coating layer is superjacent to the first coating layer, thereby capping the first coating layer; wherein the first coating layer is superjacent to the substrate.
Aspect 113. The method of Aspect 112, wherein performing an atomic layer deposition cycle to form a first coating layer comprises passing a precursor and an oxidant into the atomic deposition layer reaction chamber.
Aspect 114. The method of Aspect 113, wherein the precursor comprises (trimethyl)methylcyclopentadienylplatinum (IV); and wherein the oxidant comprises deionized water.
Aspect 115. The method of Aspect 112, wherein performing an atomic layer deposition cycle to form a second coating layer comprises passing a precursor and an oxidant into the atomic deposition layer reaction chamber.
Aspect 116. The method of Aspect 115, wherein the precursor comprises bis(cyclopentadienyl)cobalt II); and wherein the oxidant comprises ozone.
Aspect 117. The method of any one of Aspect 112-Aspect 116, wherein the substrate comprises at least one electrode.
Aspect 118. The method of Aspect 117, wherein the electrode is a cathode.
Aspect 119. The method of any one of Aspect 112-Aspect 118, wherein atomic layer deposition reaction chamber has a temperature of from about 100° C. to about 500° C.
Aspect 120. The method of Aspect 119, wherein atomic layer deposition reaction chamber has a temperature of from about 250° C. to about 350° C.
Aspect 121. The method of Aspect 120, wherein atomic layer deposition reaction chamber has a temperature of from about 280° C. to about 320° C.
Aspect 122. The method of any one of Aspect 112-Aspect 121, wherein the least one atomic layer deposition cycle to form a first coating layer for a period of from about 1 minute to about 20 minutes per cycle.
Aspect 123. The method of Aspect 122, wherein the least one atomic layer deposition cycle to form a first coating layer is from 1 to 50 cycles.
Aspect 124. The method of any one of Aspect 112-Aspect 123, wherein the least one atomic layer deposition cycle to form a second coating layer for a period of from about 1 minute to about 20 minutes per cycle.
Aspect 125. The method of Aspect 124, wherein the least one atomic layer deposition cycle to form a first coating layer is from 1 to 50 cycles.
Aspect 126. A coated electrode comprising: an electrode comprising a nanocomposite coating, wherein the nanocomposite coating comprises: a layered coating comprising: a first coating layer; and a second coating layer; wherein the first coating layer comprises discrete nanoparticles; wherein the discrete nanoparticles comprise Pt, Ag, Au, or combinations thereof; wherein the second coating layer forms a continuous conformal layer comprising metal oxide nanograins; wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni_{z}Oₓ; or combinations thereof; wherein the first coating layer is subjacent to the second coating layer; and wherein the second coating layer is superjacent to the first coating layer, thereby capping the first coating layer.
Aspect 127. The coated electrode of Aspect 126, wherein the layered coating has a total thickness of from about 1 nm to about 200 nm.
Aspect 128. The coated electrode of Aspect 127, wherein the layered coating has a total thickness of from about 1 nm to about 100 nm.
Aspect 129. The coated electrode of Aspect 127, wherein the layered coating has a total thickness of from about 1 nm to about 80 nm.
Aspect 130. The coated electrode of Aspect 127, wherein the layered coating has a total thickness of from about 1 nm to about 60 nm.
Aspect 131. The coated electrode of Aspect 127, wherein the layered coating has a total thickness of from about 1 nm to about 40 nm.
Aspect 132. The coated electrode of Aspect 127, wherein the layered coating has a total thickness of from about 1 nm to about 20 nm.
Aspect 133. The coated electrode of Aspect 127, wherein the layered coating has a total thickness of from about 2 nm to about 100 nm.
Aspect 134. The coated electrode of Aspect 127, wherein the layered coating has a total thickness of from about 2 nm to about 80 nm.
Aspect 135. The coated electrode of Aspect 127, wherein the layered coating has a total thickness of from about 2 nm to about 60 nm.
Aspect 136. The coated electrode of Aspect 127, wherein the layered coating has a total thickness of from about 2 nm to about 40 nm.
Aspect 137. The coated electrode of Aspect 127, wherein the layered coating has a total thickness of from about 2 nm to about 20 nm.
Aspect 138. The coated electrode of Aspect 127, wherein the layered coating has a total thickness of from about 2 nm to about 15 nm.
Aspect 139. The coated electrode of Aspect 127, wherein the layered coating has a total thickness of from about 2 nm to about 10 nm.
Aspect 140. The coated electrode of Aspect 127, wherein the layered coating has a total thickness of from about 5 nm to about 15 nm.
Aspect 141. The coated electrode of Aspect 127, wherein the layered coating has a total thickness of from about 5 nm to about 20 nm.
Aspect 142. The coated electrode of any one of Aspect 126-Aspect 141, wherein the continuous conformal layer comprises metal oxide nanograins distributed as a single-layer.
Aspect 143. The coated electrode of any one of Aspect 126-Aspect 142, wherein the discrete nanoparticles are elongated discrete nanoparticles.
Aspect 144. The coated electrode of Aspect 143, wherein the elongated discrete nanoparticles are from about 1 nm to about 100 nm in their longest dimension.
Aspect 145. The coated electrode of any one of Aspect 126-Aspect 144, wherein the metal oxide nanograins are elongated metal oxide nanograins.
Aspect 146. The coated electrode of Aspect 145, wherein the elongated metal oxide nanograins are from about 1 nm to about 200 nm in their longest dimension.
Aspect 147. The coated electrode of Aspect 146, wherein the metal oxide nanograins are separated from one another by from about 1 nm to about 100 nm.
Aspect 148. The coated electrode of Aspect 146, wherein the metal oxide nanograins are separated from one another by from about 1 nm to about 20 nm.
Aspect 149. The coated electrode of Aspect 146, wherein the metal oxide nanograins are separated from one another by from about 2 nm to about 20 nm.
Aspect 150. The coated electrode of Aspect 146, wherein the metal oxide nanograins are separated from one another by from about 5 nm to about 20 nm.
Aspect 151. The coated electrode of Aspect 146, wherein the metal oxide nanograins are separated from one another by from about 10 nm to about 20 nm.
Aspect 152. The coated electrode of Aspect 146, wherein the metal oxide nanograins are separated from one another by from about 15 nm to about 20 nm.
Aspect 153. The coated electrode of Aspect 146, wherein the metal oxide nanograins are separated from one another by from about 10 nm to about 15 nm.
Aspect 154. The coated electrode of Aspect 146, wherein the metal oxide nanograins are separated from one another by from about 5 nm to about 25 nm.
Aspect 155. The coated electrode of Aspect 146, wherein the metal oxide nanograins are separated from one another by from about 10 nm to about 25 nm.
Aspect 156. The coated electrode of any one of Aspect 126-Aspect 155, wherein the metal oxide nanograins are separated from one another by from about 1 nm to about 200 nm.
Aspect 157. The coated electrode of any one of Aspect 126-Aspect 155, wherein the metal oxide nanograins are separated from one another by from about 0.001 nm to about 1 nm.
Aspect 158. The coated electrode of any one of Aspect 126-Aspect 155, wherein the metal oxide nanograins are in contact with one another via intergrain boundaries.
Aspect 159. The coated electrode of any one of Aspect 126-Aspect 158, wherein the layered coating is an atomic layer deposition (ALD) coating.
Aspect 160. The coated electrode of any one of Aspect 126-Aspect 159, wherein the metal oxide nanograins comprise mixed valence metal oxide nanograins.
Aspect 161. The coated electrode of Aspect 160, wherein the mixed valence metal oxide nanograins comprise at least two of Ce_{y}Oₓ; Co_{y}Oₓ; or Pr_{y}Oₓ.
Aspect 162. The coated electrode of Aspect 160, wherein the mixed valence metal oxide nanograins comprise Co_{y}Oₓ.
Aspect 163. The coated electrode of Aspect 162, wherein x has a value of from about 0.1 to about 10.
Aspect 164. The coated electrode of Aspect 162 or Aspect 163, wherein y has a value from about 0.1 to about 2.
Aspect 165. The coated electrode of Aspect 162 or Aspect 163, wherein y has a value that is greater than or equal to about 2.
Aspect 166. The coated electrode of Aspect 162, wherein the Co_{y}Oₓ comprises CoO, CoO2, Co3O4, or combinations thereof.
Aspect 167. The coated electrode of Aspect 160, wherein the mixed valence metal oxide nanograins comprise Ce_{y}Oₓ.
Aspect 168. The coated electrode of Aspect 167, wherein x has a value of from about 0.1 to about 10.
Aspect 169. The coated electrode of Aspect 167 or Aspect 168, wherein y has a value from about 0.1 to about 2.
Aspect 170. The coated electrode of Aspect 167 or Aspect 168, wherein y has a value that is greater than or equal to about 2.
Aspect 171. The coated electrode of Aspect 167, wherein the Ce_{y}Oₓ comprises Ce₃O₄, CeO₂, or a combination thereof.
Aspect 172. The coated electrode of Aspect 160, wherein the mixed valence metal oxide nanograins comprise Pr_{y}Oₓ.
Aspect 173. The coated electrode of Aspect 172, wherein x has a value of from about 0.1 to about 10.
Aspect 174. The coated electrode of Aspect 172 or Aspect 173, wherein y has a value from about 0.1 to about 2.
Aspect 175. The coated electrode of Aspect 172 or Aspect 173, wherein y has a value that is greater than or equal to about 2.
Aspect 176. The coated electrode of Aspect 172, wherein the Pr_{y}Oₓ comprises Pr₆O₁₁, Pr₁₁O₂₀, Pr₅O₉, or combinations thereof.
Aspect 177. The coated electrode of Aspect 160, wherein the mixed valence metal oxide nanograins comprise La_{y}Ni_{z}Oₓ.
Aspect 178. The coated electrode of Aspect 177, wherein x has a value of from about 0.1 to about 10.
Aspect 179. The coated electrode of Aspect 177 or Aspect 178, wherein y has a value from about 0.1 to about 2.
Aspect 180. The coated electrode of Aspect 177 or Aspect 178, wherein y has a value that is greater than or equal to about 2.
Aspect 181. The coated electrode of any one of Aspect 177-Aspect 180, wherein z has a value from about 0.1 to about 2.
Aspect 182. The coated electrode of any one of Aspect 177-Aspect 180, wherein z has a value that is greater than or equal to about 2.
Aspect 183. The coated electrode of Aspect 177, wherein the La_{y}Ni_{z}Oₓ comprises La₂NiO₄, La₃Ni₂O₇, LaNiO₃, La₄Ni₃O₁₀, or combinations thereof.
Aspect 184. The coated electrode of any one of Aspect 126-Aspect 183, wherein a doped metal oxide nanograin comprises a dopant selected from Ni, Fe, and a combination thereof.
Aspect 185. The coated electrode of any one of Aspect 126-Aspect 184, wherein the second coating layer is essentially free from both Sr and La.
Aspect 186. The coated electrode of any one of Aspect 126-Aspect 185, wherein the electrode is a cathode.
Aspect 187. The coated electrode of any one of Aspect 126-Aspect 185, wherein the electrode is a cobaltite-based perovskite electrode.
Aspect 188. The coated electrode of Aspect 187, wherein the cobaltite-based perovskite electrode comprises lanthanum strontium cobalt ferrite (LSCF).
Aspect 189. The coated electrode of Aspect 188, wherein the cobaltite-based perovskite electrode comprises lanthanum strontium cobalt ferrite (LSCF).
Aspect 190. The coated electrode of Aspect 189, wherein the cobaltite-based perovskite electrode comprises a carbonate-based lanthanum strontium cobalt-free Sm₂O₃-doped CeO₂ (LSCF/SDC) cathode backbone.
Aspect 191. A product comprising the electrode of any one of Aspect 126-Aspect 190.
Aspect 192. The product of Aspect 191, wherein the product is a solid oxide cell (SOC).
Aspect 193. The product of Aspect 192, wherein the SOC is a solid oxide fuel cell (SOFC).
Aspect 194. The product of Aspect 193, wherein the layered coating of the nanocomposite coating acts as a blocking layer to prevent segregation of contaminants in an SOFC system.
Aspect 195. The product of Aspect 193 or Aspect 194, wherein Cr deposition from Cr-containing interconnects occurs preferentially on a segregated SrO phase; and wherein the second coating layer of the layered coating comprising metal oxide nanograins is essentially free of Cr deposition from Cr-containing interconnects.
Aspect 196. The product of any one of Aspect 191-Aspect 195, wherein the second coating layer of the layered coating comprising metal oxide nanograins separates Cr vapor from reaction with Sr cations.
Aspect 197. The product of any one of Aspect 191-Aspect 196, wherein the solid oxide cell has a series resistance that is reduced by at least 10% when compared to the substantially the same solid oxide cell with the same electrode that is uncoated.
Aspect 198. The product of Aspect 197, wherein the solid oxide cell has a series resistance that is reduced by at least 15%.
Aspect 199. The product of Aspect 197, wherein the solid oxide cell has a series resistance that is reduced by at least 20%.
Aspect 200. The product of Aspect 197, wherein the solid oxide cell has a series resistance that is reduced by at least 25%.
Aspect 201. The product of Aspect 197, wherein the solid oxide cell has a series resistance that is reduced by at least 30%.
Aspect 202. The product of Aspect 197, wherein the solid oxide cell has a series resistance that is reduced by at least 35%.
Aspect 203. The product of Aspect 197, wherein the solid oxide cell has a series resistance that is reduced by at least 40%.
Aspect 204. The product of Aspect 197, wherein the solid oxide cell has a series resistance that is reduced by at least 45%.
Aspect 205. The product of Aspect 197, wherein the solid oxide cell has a series resistance that is reduced by at least 50%.
Aspect 206. The product of any one of Aspect 191-Aspect 205, wherein the second coating layer of the layered coating comprising metal oxide nanograins prevents penetration of humidity into a cathode backbone, thereby decreasing performance degradation and increased durability and contamination tolerance of a cathode backbone.
Aspect 207. A method of making the coated electrode of any one of Aspects 126-190, the method comprising: providing an electrode in an atomic layer deposition reaction chamber; performing at least one atomic layer deposition cycle to form a first coating layer on a surface of the substrate; wherein the first coating layer comprises discrete nanoparticles; wherein the discrete nanoparticles comprise Pt, Ag, Au, or combinations thereof; performing at least one atomic layer deposition cycle to form a second coating layer on the first coating layer; wherein the second coating layer comprises metal oxide nanograins; wherein the metal oxide nanograins comprise Co_{y}Oₓ, doped Co_{y}Oₓ, Pr_{y}Oₓ, doped Pr_{y}Oₓ, Ce_{y}Oₓ, doped Ce_{y}Oₓ, La_{y}Ni_{z}Oₓ, doped La_{y}Ni_{z}Oₓ, or combinations thereof; and wherein the second coating layer forms a continuous conformal layer comprising metal oxide nanograins on the first coating layer; wherein the first coating layer is subjacent to the second coating layer; and wherein the second coating layer is superjacent to the first coating layer, thereby capping the first coating layer; wherein the first coating layer is superjacent to the substrate.
Aspect 208. The method of Aspect 207, wherein performing an atomic layer deposition cycle to form a first coating layer comprises passing a precursor and an oxidant into the atomic deposition layer reaction chamber.
Aspect 209. The method of Aspect 208, wherein the precursor comprises (trimethyl)methylcyclopentadienylplatinum (IV); and wherein the oxidant comprises deionized water.
Aspect 210. The method of Aspect 207, wherein performing an atomic layer deposition cycle to form a second coating layer comprises passing a precursor and an oxidant into the atomic deposition layer reaction chamber.
Aspect 211. The method of Aspect 210, wherein the precursor comprises bis(cyclopentadienyl)cobalt II); and wherein the oxidant comprises ozone.
Aspect 212. The method of any one of Aspect 207-Aspect 211, wherein the electrode is a cathod.
Aspect 213. The method of any one of Aspect 207-Aspect 212, wherein atomic layer deposition reaction chamber has a temperature of from about 100° C. to about 500° C.
Aspect 214. The method of Aspect 213, wherein atomic layer deposition reaction chamber has a temperature of from about 250° C. to about 350° C.
Aspect 215. The method of Aspect 214, wherein atomic layer deposition reaction chamber has a temperature of from about 280° C. to about 320° C.
Aspect 216. The method of any one of Aspect 207-Aspect 215, wherein the least one atomic layer deposition cycle to form a first coating layer for a period of from about 1 minute to about 20 minutes per cycle.
Aspect 217. The method of Aspect 216, wherein the least one atomic layer deposition cycle to form a first coating layer is from 1 to 50 cycles.
Aspect 218. The method of any one of Aspect 207-Aspect 217, wherein the least one atomic layer deposition cycle to form a second coating layer for a period of from about 1 minute to about 20 minutes per cycle.
Aspect 219. The method of Aspect 218, wherein the least one atomic layer deposition cycle to form a first coating layer is from 1 to 50 cycles.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### G. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1. Experimental Details

Commercially available, anode-supported solid oxide button cells fabricated by Materials and Systems Research, Inc. (MSRI, Salt Lake City, UT) were employed for all the experiments described in this paper. MSRI cells were composed of five layers as follows: starting from the anode: (a) a ˜700 μm thick Ni/YSZ cermet layer which supports the cell structure; (b) a ˜10 μm thick Ni/YSZ active layer; a ˜10 μm thick YSZ electrolyte; (c) a thin (2-3 μm) dense Sm₂O₃-doped CeO₂ (SDC) barrier layer, (d) a ˜10 μm thick La_{0.6}Sr_{0.4}CO_{0.2}Fe_{0.8}O_{3-δ} (LSCF)/SDC active layer; and (e) a 50 μm thick, pure LSCF current collecting layer. The active area (limited by the cathode) of the cell is 2 cm². The exposure area of the anode to fuel was about 3.5 cm².

The ALD coatings were performed in a commercial GEMStar-8 ALD reactor from Arradiance Inc. The precursors used in this study were all purchased from Strem Chemicals, Inc. The (trimethyl)methylcyclopentadienylplatinum(IV)/(99%) and the deionized water were used as Pt precursor and oxidant for depositing the Pt layer; and the bis(cyclopentadienyl)cobalt (II), (min. 98% cobaltocene) and ozone were used as Co and oxidant, respectively, for CoOₓ layer growth. During the deposition, the (trimethyl)methylcyclopentadienylplatinum and bis(cyclopentadienyl)cobalt containers were maintained at 75° C. and 90° C., respectively; and the reactor chamber was set at 300° C. Desired cycles were performed for Pt and CoOₓ deposition, respectively, leading to a dual-layer ALD coating of Pt first, followed by Co₃O₄ (120 cycles for both cells) on each cell cathode backbone. The Pt layer thickness (Pt loading level) was different for each of the exemplary ALD-coated cells, i.e., Cell #2 was processed 30 cycles and Cell #4 was processed 60 cycles and had a loading of Pt twice as Cell #2. The baseline cells (Cell #1 and 3) and exemplary ALD-coated cells (Cell #2 and 4) used in these Examples herein below are summarized in Table 1 below. No masking or specific treatment was applied on the NiO/YSZ anode before ALD processing. Without wishing to be bound by a particular theory, it is believed that the thick and very dense NiO/YSZ anode prevents precursor penetration during the ALD processing, and the impact of ALD coating on the Ni/YSZ anode is negligible. No surface pretreatment or heat-treatment was applied before or after ALD coating. The cell electrochemical operation was carried out directly after the ALD coating.

One baseline, Cell #1, and ALD-coated, Cell #2, were subjected to operation at 750° C., and another baseline, Cell #3, and another ALD-coated, Cell #4, were examined at 650° C. All cell tests were performed on a test stand. The platinum mesh was used for anode and cathode lead connections. The fuel and air stream flow rates were controlled separately using mass flow controllers. During the operation, a 400 mL/min air flow rate and a 400 mL/min fuel flow rate were used. Before any electrochemical measurements, both cells were current-treated for approximately ˜15 h under a small current density of 0.1 A/cm² to ensure they were activated. After that, the samples were loaded at a constant current of 0.3 A/cm² for desired periods. The cell performance was examined using a TrueData-Load Modular Electronic DC Load, which guarantees voltage and current accuracies of 0.03% FS of the range selected +/−0.05% of the value. The cell impedance spectra were examined using a potentiostat/galvanostat (Solartron 1287A) equipped with a frequency response analyzer (Solartron 1260). Impedance measurements were carried out using a Solatron 1260 frequency response analyzer in a frequency range from 50 mHz to 100 KHz. The impedance spectra and resistance (ohmic resistance Rₛ and polarization resistance Rₚ) presented are those measured under a DC bias current of 0.3 A/cm². On a Nyquist plot, Rₛ was determined by the intercept at the higher frequency end, and Rₚ was determined by the distance between two intercepts.

After the electrochemical operation, the ALD-coated cells were sectioned and subjected to nanostructural and crystallographic examination using high resolution (HR) Transmission Electron Microscopy (TEM). TEM samples were prepared by mechanical polishing and ion milling in a liquid-nitrogen-cooled holder. Electron diffraction, diffraction contrast, and HRTEM imaging were performed using a JEM-2100 operated at 200 kV. All the TEM examinations were conducted in the cathode active layer. Chemical analysis was carried out under TEM using energy dispersive X-ray Spectroscopy (EDS). High-angle annular dark-field (HAADF) Z-contrast imaging and nanoscale chemistry analysis were performed using an Aberration-Corrected 200 kV (JEOL 2100F) STEM with the inner cut-off angle of the HAADF detector set at >52 mrad.

TABLE 1
Exemplary Cells.

| | | | | ALD |
|---|---|---|---|---|
| Cell | Cell | | ALD | Coating |
| No. | Description | MSRI Cell (five layers)* | Coating | Parameters |
| No. 1 | MSRI cell | A ~700 μm thick Ni/YSZ | None | n.a. |
| | without ALD | cermet layer which supports | | |
| | coating | the cell structure; a ~10 | | |
| | (baseline | μm thick Ni/YSZ active | | |
| | cell). | layer; a ~10 μm thick | | |
| No. 2 | MSRI cell | YSZ electrolyte; a thin | Yes | 2 nm Pt |
| | with ALD | (2-3 μm), dense Sm₂O₃- | | layer plus |
| | coating | doped CeO₂ (SDC) barrier | | 10 nm |
| | (thickness | layer, a ~10 μm thick | | CoOₓ |
| | 1). | La_{0.6}Sr_{0.4}Co_{0.2}Fe_{0.8}O_{3-δ} | | |
| No. 3 | MSRI cell | (LSCF)/SDC active layer; | None | n.a. |
| | without ALD | and a 50 μm thick, pure | | |
| | coating | LSCF current collecting | | |
| | (baseline | layer. | | |
| | cell). | | | |
| No. 4 | MSRI cell | | Yes | 4 nm Pt |
| | with ALD | | | layer plus |
| | coating | | | 20 nm |
| | (thickness | | | CoOₓ |
| | 2). | | | |

*Layer arrangement, starting from the anode.

### Example 2. Results: Conformal Single-Layered Nanograins on LSCF/SDC Cathode at 750° C.

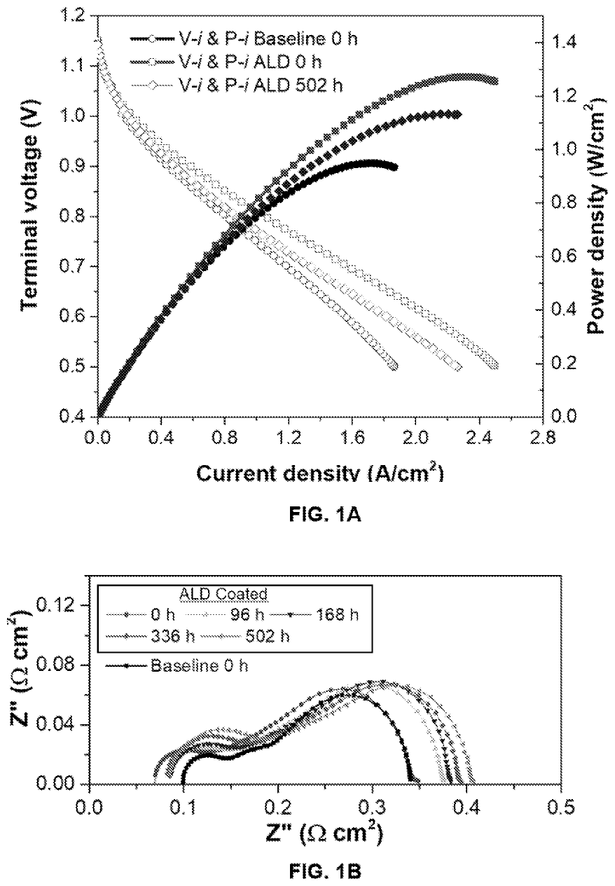

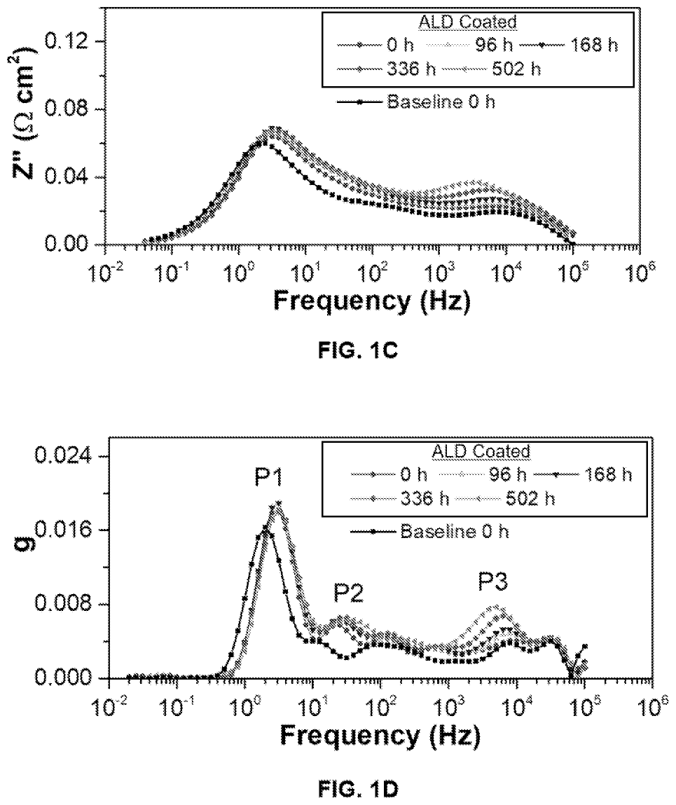

As shown in FIG. 1, upon the electrochemical operation at 750° C. for 0 h, a baseline cell, Cell #1, possessed a peak power density of 0.949 W/cm² at 0.3 A/cm², with an Rₛ value of 0.112 W cm² and Rp of 0.238 W cm². For an ALD-coated cell, Cell #2, the peak power density reached 1.273 W/cm² at 0 h, and 134% over the baseline. The power density increase was accompanied by the reduction of Rₛ to 0.068 W cm² by 39%, while the Rₚ for ALD-coated cell, Cell #2, is 0.274 W cm² and slightly higher than the baseline cell. As shown in Table 2, Rₛ increased to 0.084 W cm² after operation for 96 h. After that, Rₛ had little change from 96 h to 502 h while the Rₚ gradually increased. Due to the considerable reduction in the Rₛ, the peak power density of ALD-coated cell, Cell #2, after 502 h operation remained at 119% of that baseline cell at 0 h operation.

FIGS. 1A-1D show representative power density and impedence data for a baseline cell compared to a representative disclosed ALD-coated cell having a 2 nm Pt layer plus 10 nm CoOₓ. In the figure, “Baseline” indicates the baseline cell, Cell #1, and “ALD” refers to the representative disclosed ALD-coated cell, Cell #2. Electrochemical operation was carried out for the indicated times at 750° C. FIG. 1A shows terminal voltage as a function of current density for the baseline and ALD-coated cells. FIG. 1B shows Nyquist plots of four cells at 0.3 A/cm². FIG. 1C shows Bode plots for the baseline and ALD-coated cells at 0.3 A/cm². FIG. 1D shows corresponding deconvolution spectra of the impedance data collected from the baseline and ALD-coated cells.

TABLE 2
Impedance and Peak Power Density of the Cells #1 and #2.

| | | | | Peak | Enhancement |
|---|---|---|---|---|---|
| LSCF/SDC | Operating | Rₛ | Rₚ | power | to cell no. 1 at |
| cathode | time (h) | (Ω cm²) | (Ω cm²) | (W/cm²) | 0 h |
| Baseline Cell | 0 | 0.112 | 0.237 | 0.949 | |
| No. 1 | | | | | |
| Pt&CoOx | 0 | 0.068 | 0.274 | 1.273 | 1.34 |
| coated | 96 | 0.084 | 0.291 | — | 1.19 |
| cell no. 2 | 168 | 0.086 | 0.297 | — | — |
| | 336 | 0.082 | 0.311 | — | — |
| | 502 | 0.085 | 0.32 | 1.134 | 1.19 |

To identify the physical origin of cell performance enhancement and the slightly increased polarization registance, the dynamic constant in the impedance data was retrieved by evaluating the relaxation times and relaxation amplitude of the impedance-related processes using deconvolution (Refs. 13-14) shown in FIG. 1D. The cells exhibited one dominant arc P1 accompanied by P2 with lower magnitude, with the frequency ranging at 2-4 Hz, 20-40 Hz, respectively. The P1 and P2 arcs of the ALD-coated cell, Cell #2, shifted to the higher frequency end in comparison with that of the baseline cell, Cell #1. In general, for the cathode, the physical processes occurring at the characteristic frequencies of 5-150 Hz range could be assigned to activation polarization ORR. Without wishing to be bound by a particular theory, it is believed that depending on the cathode chemistry that the peaks can shift slightly to either direction under identical cell operation conditions (Refs. 15, 17-18). In comparison to the baseline cell, Cell #1, the ALD-coated cell, Cell #2, depicted higher amplitude P2 at ˜20-40 Hz. It is recognized in the literature that the physical origin of the P2 arcs that arise at ˜70 Hz are primarily due to oxygen transport along the surface and/or through the bulk in the cathode and electrolyte. Thus, based on the data disclosed herein for the exemplary ALD-coated cells, it appears that the ALD coating of a Pt—CoOₓ dual layer on the surface of LSCF/SDC cathode has changed the cathode reaction pathways and introduced two apparently different cathodic polarizations. Without wishing to be bound by a particular theory, it is believed that each of the polarizations can have distinct dissociative oxygen adsorption and transport of oxygen species to the electrochemically active sites. For the ALD-coated cell, Cell #2, the data show that P2 slightly increased during operation. However, P1 continuously decreased, suggesting that slightly, but continuously, accelerated ORR and oxygen transport occurs upon operation.

The operation also introduced an increase in the P3 peak in the ALD-coated cell, Cell #2, at high-frequency range 4752-9000 Hz. It has been suggested previously that Peak P3 may be associated with charge transfer across the electrode/electrolyte interface, which is independent of the oxygen partial pressure (Ref. 19). Accordingly, P3 is expected to be present in both the exemplary ALD-coated cell and the baseline cell. Without wishing to be bound by a particular theory, the increase of P3 can be related to the formation of insulating phases in the cathode. For example, a possibility is formation of a SrZrO₃ phase takes place at the interface between the SDC barrier layer and the LSCF due to the solubility of Sr in the barrier layer phase.

Based on the impedance deconvolution, the subsequent equivalent circuit fitting and the capacitance analysis was performed (see herein below). The ALD-coated cell, Cell #2, had lower chemical capacitance than the baseline cell, Cell #1, suggesting less involvement of the cathode backbone through the oxygen reduction reactions and related mass and charger transfer (Ref. 20). Furthermore, the ALD-coated cell, Cell #2, appears to be associated with continuous reduction of chemical capacitance (Refs. 43-44), with the increase of operation, revealing the continuously increased surface transport and reactions in the overall electrode reaction in the ALD-coated cell.

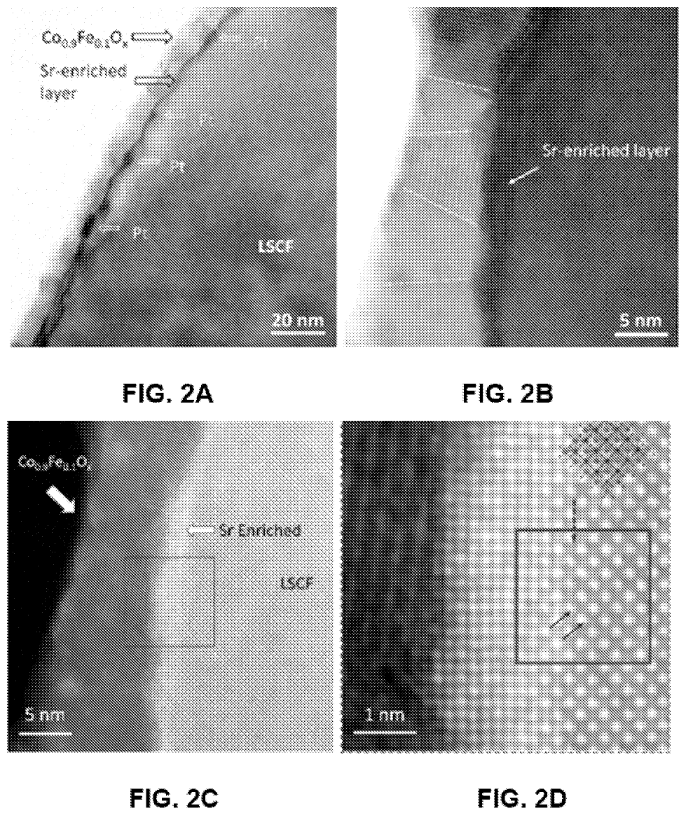

FIGS. 2A-2D show representative transmission electron microscopy images of a representative disclosed ALD-coated cell having a 2 nm Pt layer plus 10 nm CoOₓ after operation at 750° C. for 502 h. FIG. 2A shows a representative conformal dense Co_{0.9}Fe_{0.1}Oₓ film covering the discrete Pt particles with a Sr-enriched interface phase between the Co_{0.9}Fe_{0.1}Oₓ film and the LSCF backbone. FIG. 2B shows a representative STEM bright field imaging depicting the Co_{0.9}Fe_{0.1}Oₓ having single-layered nanograins with high-density intergranular grain boundaries and surface grain boundaries. The Sr-enriched layer is ˜2 nm thick. FIG. 2C shows a representative STEM dark-field imaging is taken from the direction of LSCF. The Sr-enriched layer is shown at the interface (brighter contrast indicating the enrichment of heavy element). FIG. 2D shows an enlarged box area from FIG. 2C which shows the region of the interface between the Sr-enriched phase and the LSCF grain as indicated by the dashed arrow. As these images show, the Sr-enriched interface is fully epitaxial and coherent with the LSCF grain, presenting the same atom arrangement of that LSCF grain. The Sr-enriched interface shares the same La/Sr site column intensity of LSCF. However, the Co/Fe site column intensity is much stronger than that of LSCF.

Overall, the ALD-coated cell exhibited slightly higher Rₚ for both ORR and oxygen transport. The increased power density can be attributed to the decreased Rₛ, suggested that the ALD coating has introduced additional mass or charge transfer pathways. Post-mortem nanostructural examination indicated that the ALD layer had a thickness of ˜10 nm and appeared to be fully conformal, dense, and uniform (see FIGS. 2A-2B). The conformal coating consisted of single-layered CoOₓ grains (7-10 nm in dimension), capping the subjacent layer of discrete elongated Pt (˜2×5 nm in size) nanograins that are ˜20 nm apart. The single-layered CoOₓ grains with random orientations had a very high-density of intergranular and surface grain boundaries. The chemistry of the ALD layer was close to Co_{0.9}Fe_{0.1}Oₓ with a small amount of Fe diffusion from LSCF, while it is free of Sr and La. Thus, this dense conformal CoOₓ coating could have suppressed the Sr further surface segregation. Accordingly, without wishing to be bound by a particular, a CoOₓ layer could also act as a blocking layer to prevent the attack from other common contaminants in the SOFC system. For example, it has been reported that Cr deposition occurs preferentially on segregated SrO but not on Co₃O₄ (Ref. 21), and a dense Co₃O₄ layer can separate the Cr vapor from its reaction with Sr cation (Ref. 22). Another example is a dense coating layer preventing penetration of humidity into the cathode backbone, thereby preventing significant performance degradation (Ref. 23). In short, an increased intrinsic durability and contamination tolerance was demonstrated in the exemplary cell due to the conformal ALD coating.

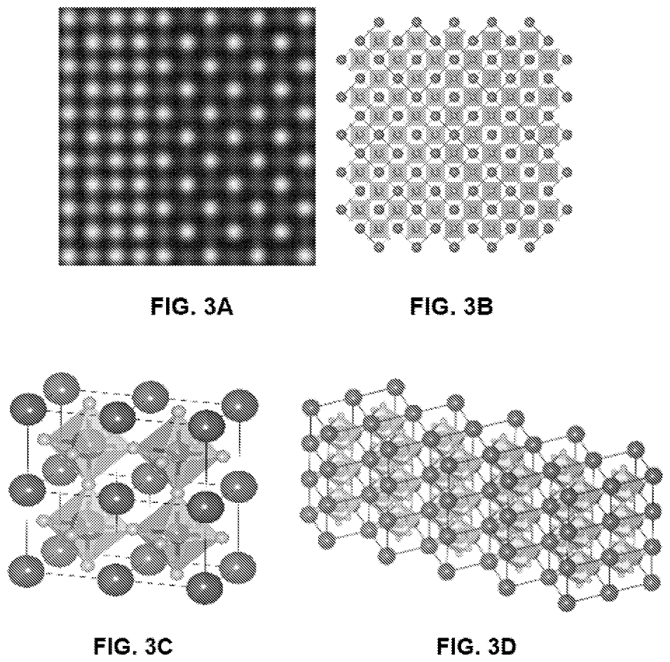

Underneath the superjacent layer, an ultra-thin layer was confined at the interface between CoOₓ and the LSCF bulk phase (see FIGS. 2C-2D). As shown in the STEM image in FIG. 2C, this interface layer shows a brighter contrast, revealing the segregation of the atoms with heavier atomic numbers. TEM/EDS analysis (the electron beam sampling size ˜20 nm) was conducted and showed that the typical La/Sr ratio for the intragranular LSCF grains is 6/4 as expected for the LSCF phase. In contrast to the CoOₓ/bulk LSCF interface region, the La/Sr ratio is 4/6. These data suggest that Sr was enriched in this interface layer. The atomic resolution Z-contrast (FIG. 2D) taken from direction of the LSCF revealed that the La/Sr lattice arrangement of this Sr-enriched layer was not different from that of the bulk LSCF. However, the Fe/Co column in the Sr-enriched layer depicted higher intensity than that in the LSCF bulk grains. Brighter contrast of atom columns suggests substitution of heavier elements (in this case Sr) in the Fe/Co sites. A multi-slice simulation was performed accordingly and confirmed that, when 50% of Fe or Co are substituted by Sr, the Fe/Co atomic columns present the increased intensity, as shown in FIG. 3. In other words, the chemistry of the Sr-enriched layer was determined as (La_{0.6}Sr_{0.4}) (CO_{0.1}Fe_{0.4}Sr_{0.5})Oₓ.

FIGS. 3A-3D show representative simulated STEM dark-field imaging from the boxed area in FIG. 2D. FIG. 3A shows detail of the boxed area in FIG. 2D. FIG. 3B shows simulated atom arrangement of the simulated area in FIG. 3A. In the Sr-enriched region, the La/Sr columns are the same as that of LSCF grain. However, 50% of Co/Fe atom columns are substituted by Sr. FIG. 3C shows the simulated atomic structure at the interface between the Sr-enriched interface phase and the LSCF, depicting the larger ionic size of Co/Fe site in the Sr-enriched phase. FIG. 3D shows the simulated 3D structure of the interface region.

### Example 3. Results: Conformal Superjacent Single-Layered Nanograins on LSCF/SDC Cathode at 650° C.

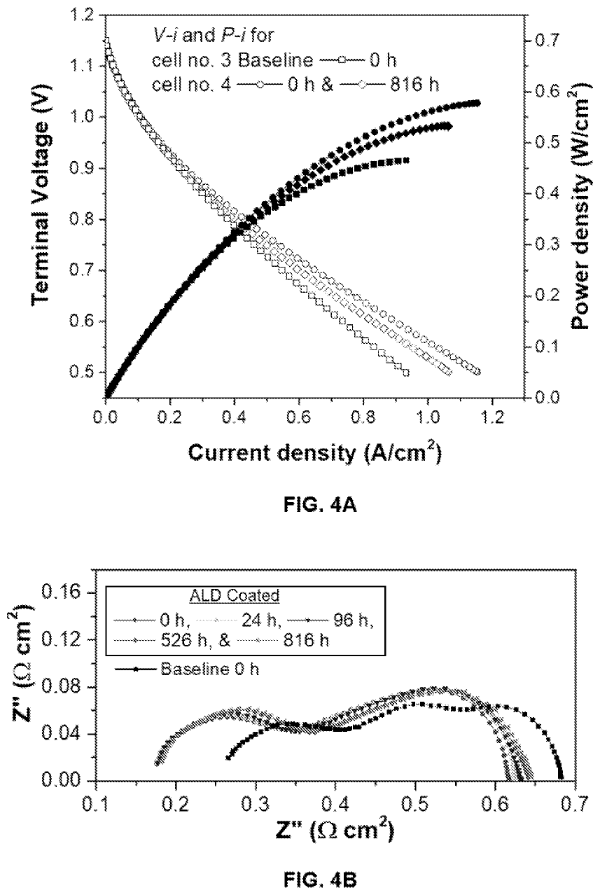

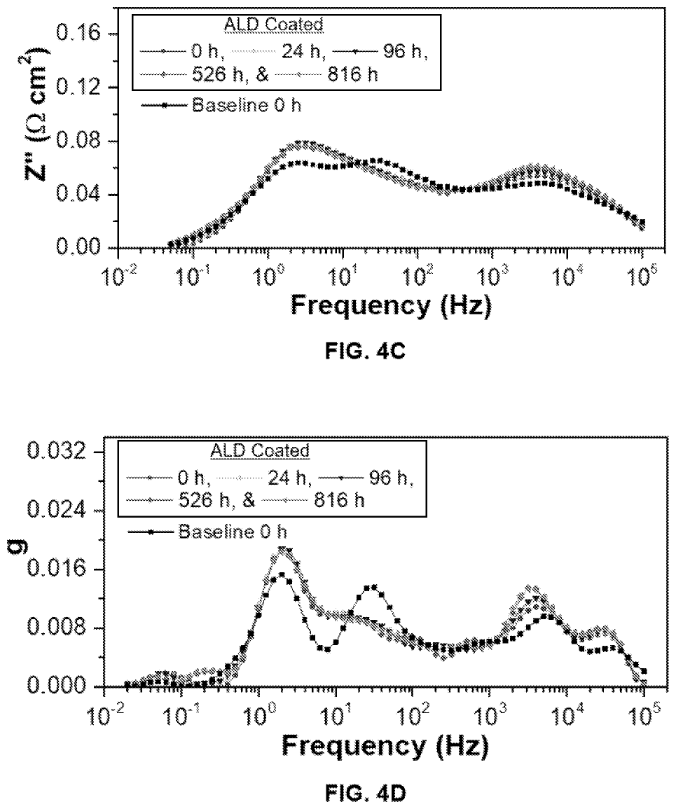

The increased conductivity induced by the ALD layer appeared to be tunable by adjusting the loading of the Pt. ALD-coated cell, Cell #4, had a Pt loading that was doubled compared to ALD-coated cell, Cell #2. ALD-coated cell, Cell #4, when operated at 650° C., the initial peak power density was 0.578 W/cm² at 0 h, and 134% over the baseline cell no. 3 of 0.463 W/cm² (shown in FIG. 4). Rₛ and Rₚ were 0.163 W cm² and 0.454 W cm², respectively, for ALD-coated cell, Cell #4, and 0.247 W cm² and 0.442 W cm², respectively for baseline cell, Cell #3, respectively. The impedance data indicates that a substantial reduction was reached for Rₛ, i.e., a reduction of 34%, compared to baseline cell. After operation for 816 h, ALD-coated cell, Cell #4, still exhibited a peak power density of 0.533 W/cm², and Rₛ and Rₚ are 0.168 W cm² and 0.479 W cm², which was 92% of its initial power density.

FIGS. 4A-4D show representative power density and impedance data for a baseline cell compared to a representative disclosed ALD-coated cell having a 4 nm Pt layer plus 20 nm CoOₓ. In the figure, “Baseline” indicates the baseline cell, and “ALD” refers to the representative disclosed ALD-coated cell. Electrochemical operation was carried out for the indicated times at 750° C. FIG. 4A shows terminal voltage as a function of current density for the baseline and ALD-coated cells. FIG. 4B shows Nyquist plots of four cells at 0.3 A/cm². FIG. 4C shows Bode plots for the baseline and ALD-coated cells at 0.3 A/cm². FIG. 4D shows corresponding deconvolution spectra of the impedance data collected from the baseline and ALD-coated cells.

A deconvolution study indicated that peak of P1 of the baseline cell, Cell #3, was close to that of P1 of a baseline cell, Cell #1, operated at 750° C. However, there was a large increase in the P2 in the ALD-coated cell, Cell #4. Without wishing to be bound by a particular theory, it is believed that this could be attributed to the increased resistance of O₂ transport when the operating temperature was lowered from 750° C. to 650° C. The P1 from the ALD-coated cell, Cell #4, was higher than the baseline cell, Cell #3, suggesting a slightly higher ORR resistance after ALD coating. However, the P2 for ALD-coated cell, Cell #4, was much lower, indicating accelerated oxygen transport along the surface due to the ALD coating layer. Interestingly, for ALD-coated cell, Cell #4, both P1 and P2 remained at their same positions, suggesting that the surface layer was very stable upon the electrochemical reactions for over 800 h. Furthermore, both P1 and P2 decreased significantly, showing slight but continuous improvement of the oxygen surface exchange, oxygen adsorption/desorption, dissociation, and/or surface transport. As shown in examples herein below, there was decreased chemical capacitance (Refs. 43-44), suggesting less involvement of the cathode bulk in the overall electrode reaction in the ALD-coated cell.

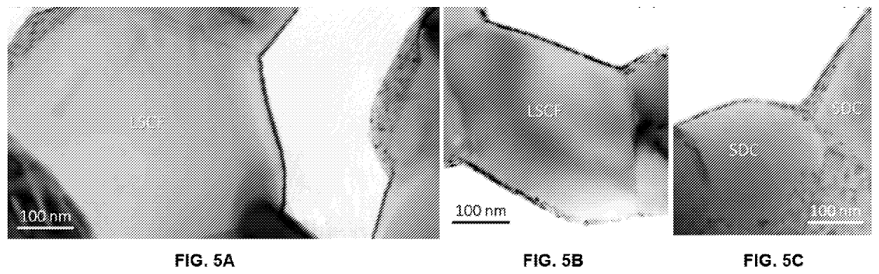

Post-mortem nanostructural examination indicates that the ALD layer remained intact and has the same morphology of that as-deposited state and is conformal on both the LSCF and SDC grain surfaces after operation for 816 h (shown in FIG. 5). FIGS. 5A-5C show representative transmission electron microscopy images of a representative disclosed ALD-coated cell having a 4 nm Pt layer plus 20 nm CoOₓ after operation for 816 h at 650° C. FIG. 5A shows the as-deposited conformal fully dense ALD coating layer. FIG. 5B shows the conformal ALD film on LSCF backbone. FIG. 5C shows conformal ALD layer on SDC backbone.

### Example 4. Coating Altered the Oxygen Reduction Reactions Pathways and Accelerated Mass-Transfer Through Surface Nanoionics Via the Strained Interface

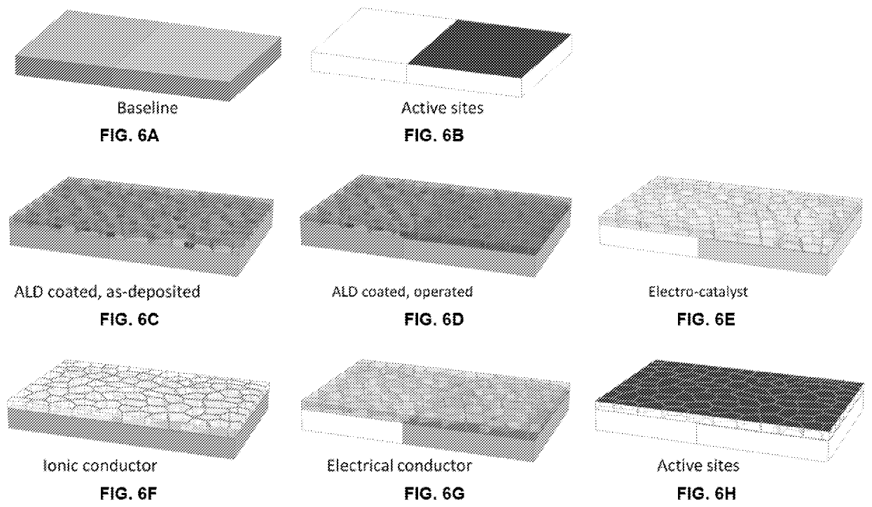

Based on the results of both ALD-coated cells, i.e., Cell #2 and Cell #4, the ORR pathways and the schematics for possible surface nanoionics of LSCF cathode are suggested as shown in FIG. 6. For the baseline cathode, without wishing to be bound by a particular theory, it is believed that the ORR takes place on the surface of LSCF. For the ALD-coated cells, the conformal and dense ALD film is less permeable to oxygen and thus possibly reduces the activity of LSCF serving as the ORR sites. Instead, the surface nano-grained CoOₓ phase becomes the oxygen reduction sites. Electrocatalytic CoOₓ covers both the LSCF and SDC phases and provides two distinguishable ORR sites that are also evidenced by the P1 and P2 peaks in impedance deconvolution (FIG. 1d). Though the nano-grained CoOₓ shows inferior catalytic activity comparing to that of the LSCF, the increased active sites on SDC surfaces may partially compensate for the loss of the LSCF catalytic activity.

FIGS. 6A-6H show representative schematic diagrams of the surface architecture of a baseline cell (FIG. 6A) compared to a representative disclosed ALD-coated cell (FIGS. 6C-6H), e.g., a LSCF cathode backbone with 8-10 nm Pt+CoOₓ layer. FIG. 6A shows a representative LSCF phase, SDC phase and their phase boundary (interface) in a baseline cell (uncoated cell). FIG. 6B shows representative ORR sites for baseline cell. FIG. 6C cell no. 2 cathode backbone with as-deposited conformal Pt+CoOₓ layer. FIG. 6D Surface layer after the electrochemical operation at 750 (or 650) ° C. FIG. 6E Distribution of electrocatalyst after the operation. FIG. 6G Distribution of ionic conductor after the operation. FIG. 6G Distribution of electrical conductor after the operation. FIG. 6H Expected cathode active ORR sites for cell with surface coating layer.

Without wishing to be bound by a particular theory, the CoOₓ layer is fully dense and has low oxygen permeability, it is possible that Pt has an effective pathway to access oxygen. Further, without wishing to be bound by a particular theory, it is believed that Pt at the interface primarily can facilitate the formation of the CoOₓ layer and further stabilize this layer over the cell operation. Without the Pt, an ALD coating of unary CoOₓ cannot form a conformal CoOₓ layer on either LSCF or SDC grains (Ref. 24). In the exemplary cells disclosed herein, discrete nano-Pt is immiscible with its neighboring CoOₓ and LSCF phases. Further, without wishing to be bound by a particular theory, it is believed that nano-Pt may provide interface strain to stabilize the formation of the conformal nanoionics (Refs. 25-26). It is worthwhile to point out the higher Pt loading in ALD-coated cell, Cell #4, did not promote the conductivity. The CoOₓ+Pt coating layer in ALD-coated cell, Cell #4, reduced 34% Rₛ over the baseline cell, while the reduction of Rₛ was 39% for ALD-coated cell, Cell #2, with only half Pt loading. Further, without wishing to be bound by a particular theory, it is believed that nano-Pt at the interface between CoOₓ phase and LSCF phase might have negative impact to the cathode conductivity. It is reported that the difference in the Fermi level can result in the occurrence of electronic/ionic charge redistribution for the oxide surrounding the Pt particles (Ref. 27). Pt changed the oxide with which it is in contact into a resistance phase, resulting in the formation of a resistive oxide layer on the surface of Pt. Therefore, in the disclosed ALD-coated cells, it may useful to control the maximum loading of dispersed Pt embedded at an interface to facilitate the percolation network and avoid the formation of a continuous resistance layer around Pt.

Overall, the ORR pathways can be shifted from the original LSCF surface to the CoOₓ surface in the ALD-coated cells. Though the more active LSCF surface is covered, a full extension of the CoOₓ active sites to the entire backbone surface is obtained. Also, the dissociated oxygen ion can only transport via the CoOₓ intergranular grain boundaries due to the existence of a fully dense CoOₓ outer shell layer.

Besides acting as catalytic oxygen reduction sites, the single 7-10 nm CoOₓ layer appears to carry sufficient conductivity in view of the foregoing data. The bulk scale Co₃O₄ phase may be an amphoteric semiconductor with intragranular low electronic conductivity (˜2 S cm⁻¹ at 600° C.; see Ref. 28) and was two orders of magnitude lower than bulk LSCF (˜100 S cm⁻¹ at 600° C.). However, a 133-134% cell performance enhancement may be primarily attributed to the decreased Rₛ (Ref. 3). Without wishing to be bound by a particular theory, it is believed that increased conductivity induced by the conformal CoOₓ layer was facilitated by fast ion transport through the high-density, high-density grain boundaries, including the surface grain boundaries from the single-layered CoOₓ nanograins (Refs. 29-34). In general, the high series resistance in the oxygen electrode may be due to the low mobility of the ionic charge carriers and their mechanical and Coulombic interactions with their host crystal structures (Ref. 34). Error! Bookmark not defined.By contrast, in comparison with the intragrain conductivity, there is faster oxide-ionic conductivity along grain boundaries that are commonly associated with higher oxygen vacancy concentration. One example is that La_{0.8}Sr_{0.2}MnO₃ (LSM) grain boundaries exhibits 5-6 orders of magnitude of enhancement in oxide-ion diffusivity compared with the bulk LSM. The enhancement might be associated with strain-induced defects and corresponding changes in the oxidation states of LSM constituent cations (Ref. 30, 34-35). Dominating of ionic conductivity at the grain boundary level has been previously reported for La_{0.6}Sr_{0.4}CoO₃ (Ref. 36-37) In terms of high ionic conductivity of Co-based nanograins, the formation of (MnCo)Oₓ nanoionics implanted on the surface pure electronic conductor LSM was previously demonstrated (Ref. 38). However, for the mixed conducting LSCF/SDC backbone, it has not been shown heretofore and the present study is the first demonstration of electrocatalytic surface nanoionics that are implanted on the surface of the inherently functional SOFC. Such surface nanoionics, as disclosed herein, enable a nanostructured electrode—which has been pursued for decades for practical SOFC.

In addition, to facilitate the formation of nanoionics and prevent Sr surface segregation, the ALD coating further tuned the conductivity through the simultaneously formed Sr-enriched interface layer. The impact of this Sr-enriched layer on the conductivity of LSCF grain appears to be at least two-fold.

Firstly, for the Sr-enriched layer alone, when Sr²⁺ replaced Fe or Co cations with a higher valence state, it caused a decrease in the charge carrier concentration and led to lower electrical conductivity. Meanwhile, there was a small amount of Co cations substituted for the Fe in the Sr-enriched layer, evidenced by the presence of a small amount of Fe cation inside the CoOₓ coating layer. For the perovskite LSCF, Co ions on the Co/Fe sites can have smaller binding energy for oxygen than that with Fe ions (Refs. 3, 39). Without wishing to be bound by a particular theory, it is believed that increasing the Co content can increase the electrical conductivity. Accordingly, the decreased electrical conductivity due to Sr enrichment can be compensated by Co substitution of Fe. Meanwhile, when a stable valent cation (Sr⁺²) replaces a multivalent cation (oxidation state +3 and +4) in the system, the charge compensation of B-site cation can be achieved by the development of oxygen-deficient nonstoichiometry (Ref. 40). Further, without wishing to be bound by a particular theory, it is believed that the Sr-enriched layer has high oxygen vacancy and possesses high ionic conductivity.

Secondly, the Sr-enriched layer imposed a strain field at its lateral interface with the LSCF grain surface. The Sr-enriched layer possessed the same perovskite structure of that LSCF, shared the same kind of atomic structure in the La/Sr site, and was fully coherent to the LSCF grain as shown in FIG. 3D. However, due to the larger ionic size of Sr ions in comparison with Co and Fe, the Sr-enriched layer may have a larger lattice parameter than that of the LSCF grain as schematized in FIG. 3C, which can spontaneously impose tensile strain on the LSCF grain surface. Such tensile strain increased the interatomic distance and weakened the atomic bonding strength on the surface layer of LSCF grains. Therefore, oxygen vacancies and ionic conductivity increased accordingly.

Such analysis of the impact of the strain field effect of ionic conductivity is consistent with some prior studies. At the interface of laterally aligned heteroepitaxial YSZ film grown on SrTiO₃ substrate, up to eight orders of magnitude enhanced conductivity was observed near room temperature (Ref. 41). Such a huge increase of conductivity was ascribed to the lattice expansion of atomic layers of YSZ phase elongated by the SrTiO₃ substrate with 7.5% tensile strain. For LSM, it was predicted by Density Function Theory calculation that tensile strain could improve ion diffusion up to 2 orders of magnitude at 800 K by increasing the migration space of oxygen in the lattice and by reducing the bonding strength between the oxygen and cations (Ref. 42). Such an increase of the conductivity of the strained interface are usually achieved in various nanocomposite grown by pulsed laser deposition (Refs. 43-44). Nonetheless, that substrate-strained engineered interface usually needs to be introduced by the epitaxial growth on the substrate with a well-defined orientation. The implantation of such strained interface in the real electrochemical devices with randomly orientated grains has been found to be typically limited. Thus far, there has been no prior suggestion or realization of the strained multi-layer on the SOFC electrode that needs the enhanced interfaces and grain boundaries for increased catalytic activity and conductivity (Refs. 45-47).

In present examples, planar strained lattices were generated spontaneously between the LSCF and Sr-enriched layer that is fully coherent to the LSCF. The strained pathways formed at the interface between the ALD layer and the LSCF, were fully conformal. Once again, when the ALD-coated layer with the strained interface was applied to the internal surface of the cathode, it remarkably decreased the entire cell Rₛ by up to 40%. As discussed herein below, factoring in the thickness of ALD layer of 10 nm on the internal surface of cathode with micron-sized grains, and taking the cell resistance as the contribution of cathode, anode, and electrolyte, it was roughly estimated that the conductivity of the ALD layer. At 750° C., the conductivity of the ALD layer with the total thickness around ˜10 nm, with the combination of conformal CoOₓ layer, Sr-enriched layer, and the strained interface, was estimated to have a conductivity of ˜1.27×10⁴ S/cm, was approximately two orders magnitude of that of LSCF at 750° C.

Most importantly, such surface nanoionics are remarkably stable as evidenced by the intact nanostructure of the coating layer even after 816 h of operation at 650° C., as shown in FIG. 5. Such stable nanostructure morphology was entirely consistent with the electrochemical performance. In ALD-coated cell, Cell #4, there was observed a continuous accelerated transport of oxygen species and continuously reduced oxygen transport resistance upon operation. Without wishing to be bound by a particular theory, it is believed that the increased conductivity may be due, in part, to the minimal amount of Fe incorporation into the CoOₓ layer during the operation. Most importantly, the CoOₓ conformal coating that also facilitated the Sr-enriched layer at its strained interface could be continuous and contributing to the increased conductivity.

The present exemplary cells have superior stability at elevated temperatures, ultra-thin electrocatalytic surface nanoionics and are associated with Sr-enriched strained interface phase have become interfaces-dominated for maximized mass transport and oxygen reduction reactions. The disclosed ALD coating appears to be the most promising approach to conveniently utilizing the grain boundary and strain engineering to increase the reaction kinetics of inherent functional devices.

### Example 5. Impedance Data and Simulations

The impedance decovolution were performed based on the well-developed and excised protocals by different researchers (Refs. 16, 48-52). The devolution steps include: (a) processing the out-of-phase impedance Z″ to remove inductance and to extrapolate the Z″ data to very high and very low frequencies; (b) applying the Fast Fourier Transform (FFT) to the Z″ vs frequency data set; (c) dividing each element of the Z″ transform by the equivalent FFT element of the hyperbolic secant function; (d) filtering the dividend to remove high frequency noise; and (e) performing the inverse FFT to produce the deconvolution spectrum. From the deconvolution spectra, the number of arc-forming elements is identified. The protocol (Ref. 48) for obtaining the appropriate equivalent circuit and their best fit parameters requires iterative steps: (a) Prior to fitting the equivalent circuit to the impedance data, the impedance of the equivalent circuit is calculated; (b) the parameters are adjusted to get an approximate match while making sure that the peak frequencies obtained from the deconvoluiton spectra are preserved; (c) Then ZView® software is used to obtain the least squares fit of the equivalent parameters to the data.

Based on the deconvolution spectra and the preceding considerations, the proposed equivalent circuits contain a series resistance, and five arc-generating elements (RQ). The most common RQ is a parallel combination of a charge transfer resistance and a constant phase element CPE. The admittance Y of the CPE is dependent on two parameters, a magnitude |Q| and an exponent n (0<n≤1), Y=|Q|(jω̅)ⁿ. The peak frequency of the (RQ) element is matched to peaks in the deconvolution spectrum through the equation Fₚ=1/(2πR|Q|)^{1/n} (Ref. 48).

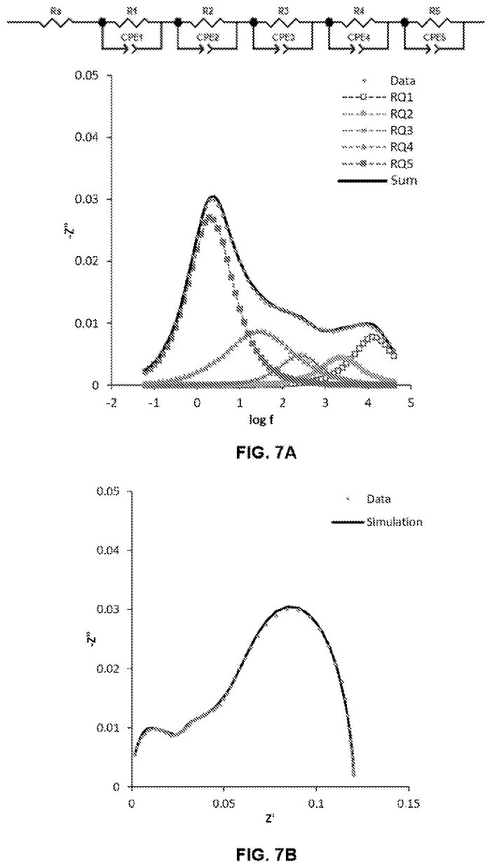

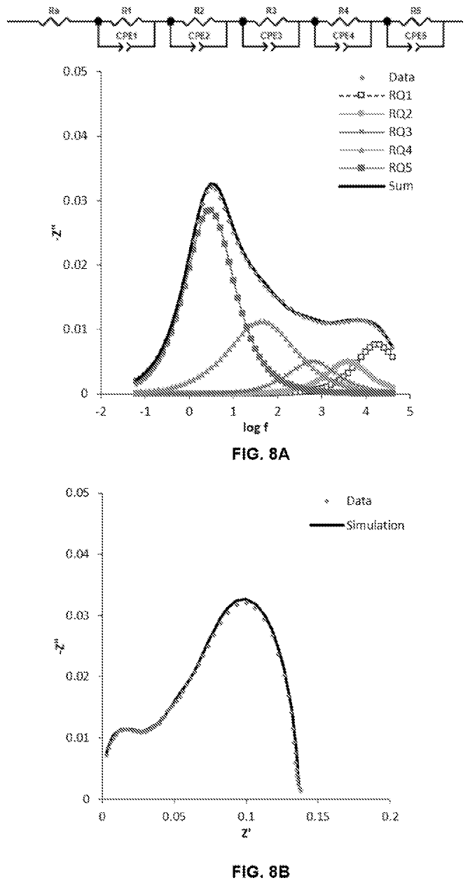

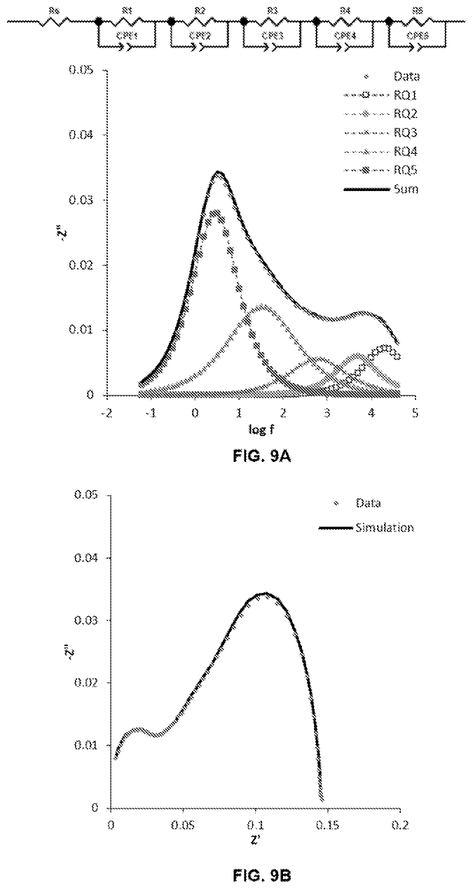

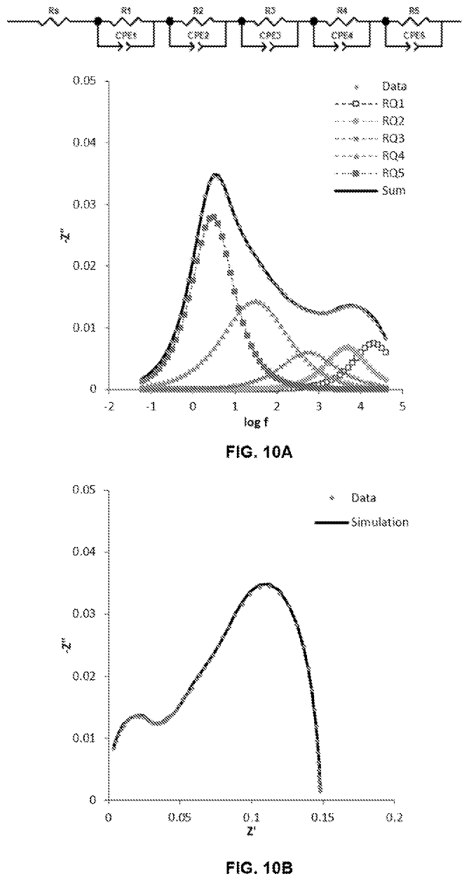

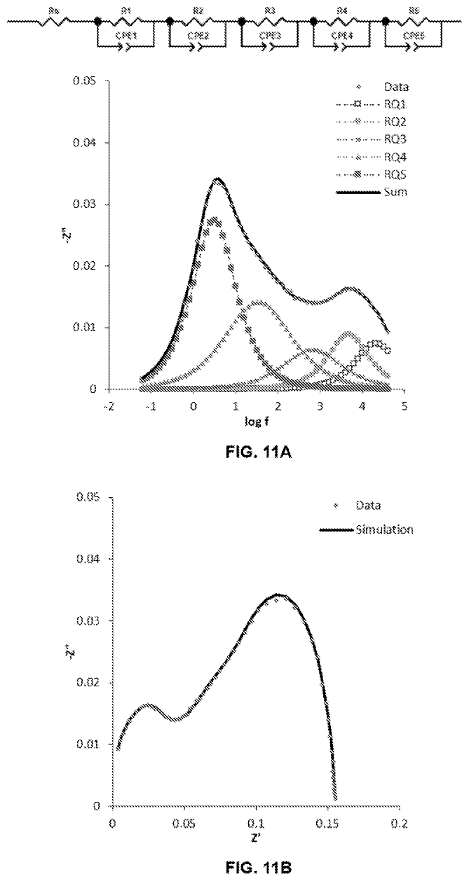

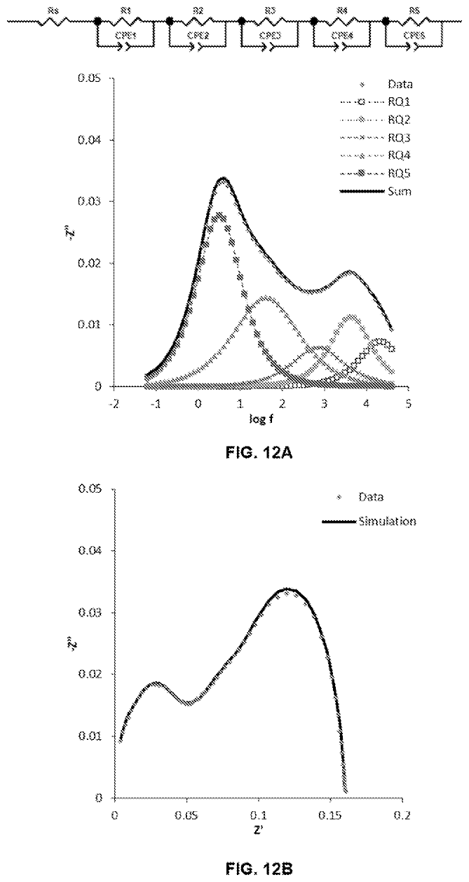

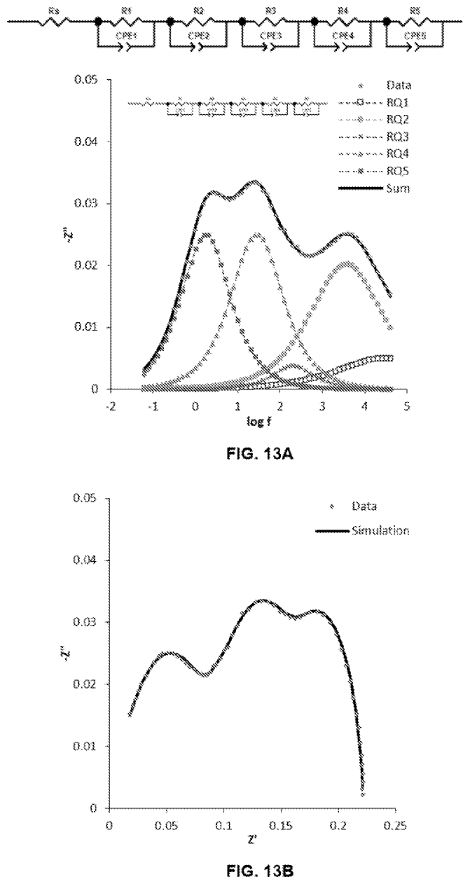

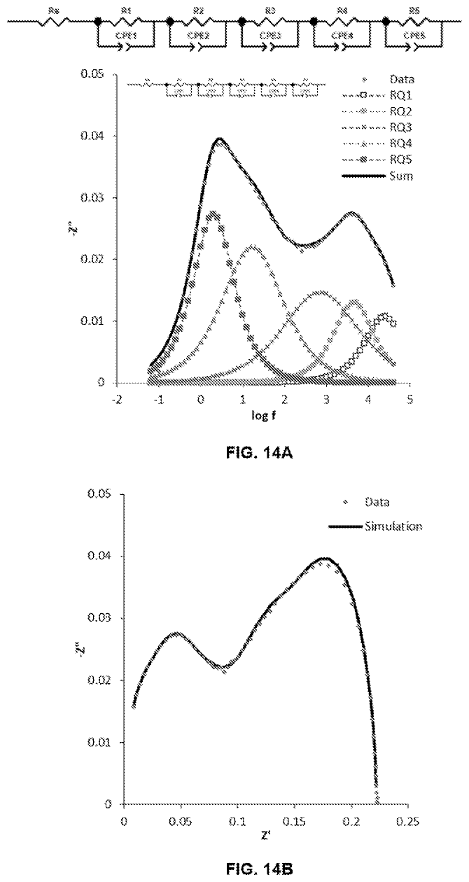

The data and simulation plots for baseline and ALD-coated at 750° C. are shown in FIGS. 7A-12B using the equivalent circuit to impedance data for baseline and ALD-coated at 750° C. listed in Table 3 below.

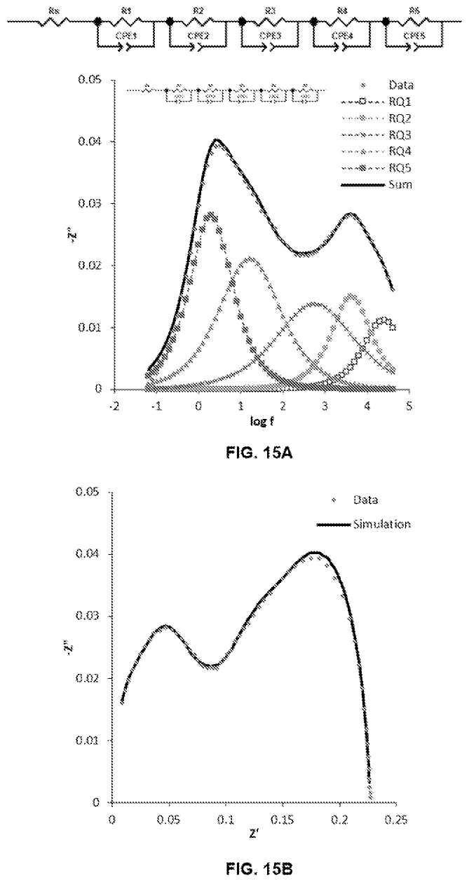

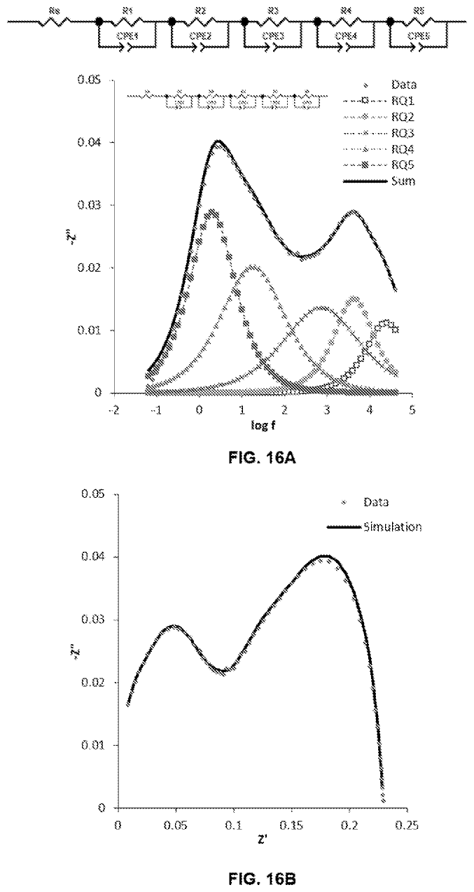

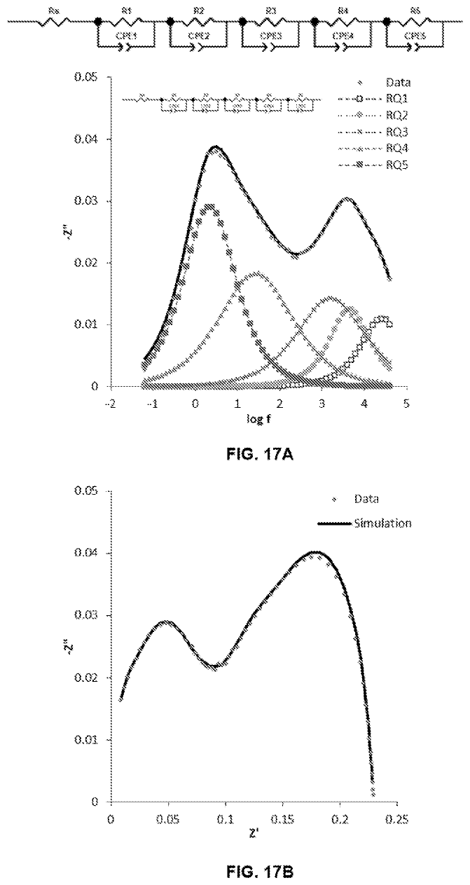

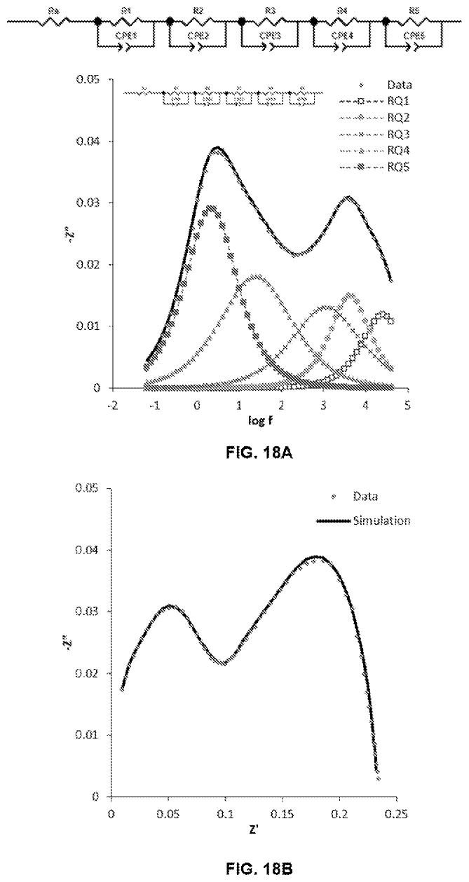

The data and simulation plots for baseline and ALD-coated at 750° C. are shown in FIGS. 13A-18B using the equivalent circuit to impedance data for baseline and ALD-coated at 650° C. listed in Table 4 below.

TABLE 3
Fitted parameters for the equivalent circuit to impedance data for baseline
and ALD-coated at 750° C..

| | | ALD- | ALD- | ALD- | ALD- | ALD- |
|---|---|---|---|---|---|---|
| Fitting | Baseline | coated at | coated at | coated at | coated at | coated |
| parameter | at 30 h | 0 h | 96 h | 168 h | 336 h | at 502 h |
| Rₛ (Ω cm²) | 0.0998 | 0.0695 | 0.0839 | 0.0858 | 0.0818 | 0.0848 |
| f1 (Hz) | 13493.86 | 17910.20 | 20133.15 | 19957.87 | 20984.28 | 20756.29 |
| R1 (Ω cm²) | 0.031 | 0.031 | 0.029 | 0.030 | 0.030 | 0.029 |
| Q1 | 0.0004 | 0.0003 | 0.0003 | 0.0003 | 0.0003 | 0.0003 |
| n1 | 1.00 | 1.00 | 1.00 | 1.00 | 1.00 | 1.00 |
| C (F cm⁻²) | 3.84 × 10⁻⁴ | 2.92 × 10⁻⁴ | 2.73 × 10⁻⁴ | 2.68 × 10⁻⁴ | 2.55 × 10⁻⁴ | 2.60 × 10⁻⁴ |
| f2 (Hz) | 2340.97 | 3864.97 | 4843.64 | 4594.84 | 4733.25 | 4222.83 |
| R2 (Ω cm²) | 0.018 | 0.020 | 0.024 | 0.027 | 0.036 | 0.045 |
| Q2 | 0.0038 | 0.0021 | 0.0014 | 0.0013 | 0.0009 | 0.0008 |
| n2 | 1.00 | 1.00 | 1.00 | 1.00 | 1.00 | 1.00 |
| C (F cm⁻²) | 3.83 × 10⁻³ | 2.05 × 10⁻³ | 1.38 × 10⁻³ | 1.27 × 10⁻³ | 9.44 × 10⁻⁴ | 8.34 × 10⁻⁴ |
| f3 (Hz) | 259.40 | 618.26 | 604.26 | 562.10 | 652.50 | 706.28 |
| R3 (Ω cm²) | 0.019 | 0.023 | 0.030 | 0.032 | 0.036 | 0.032 |
| Q3 | 0.0315 | 0.0229 | 0.0378 | 0.0413 | 0.0417 | 0.0244 |
| n3 | 1.00 | 0.91 | 0.63 | 0.81 | 0.78 | 0.85 |
| C (F cm⁻²) | 3.15 × 10⁻² | 1.11 × 10⁻² | 6.91 × 10⁻⁴ | 8.74 × 10⁻³ | 6.79 × 10⁻³ | 7.02 × 10⁻³ |
| f4 (Hz) | 29.00 | 44.32 | 32.78 | 30.55 | 34.25 | 40.75 |
| R4 (Ω cm²) | 0.056 | 0.070 | 0.087 | 0.091 | 0.091 | 0.091 |
| Q4 | 0.4415 | 0.2330 | 0.2600 | 0.2530 | 0.2440 | 0.2030 |
| n4 | 0.71 | 0.73 | 0.75 | 0.72 | 0.71 | 0.72 |
| C (F cm⁻²) | 9.84 × 10⁻² | 5.14 × 10⁻² | 7.47 × 10⁻² | 5.74 × 10⁻² | 5.12 × 10⁻² | 4.29 × 10⁻² |
| f5 (Hz) | 2.10 | 2.93 | 2.89 | 2.95 | 3.10 | 3.20 |
| R5 (Ω cm²) | 0.117 | 0.130 | 0.122 | 0.117 | 0.119 | 0.123 |
| Q5 | 0.7400 | 0.5320 | 0.5260 | 0.4990 | 0.5020 | 0.4920 |
| n5 | 0.95 | 0.92 | 0.96 | 0.97 | 0.95 | 0.94 |
| C (F cm⁻²) | 6.45 × 10⁻¹ | 4.18 × 10⁻¹ | 4.69 × 10⁻¹ | 4.64 × 10⁻¹ | 4.34 × 10⁻¹ | 4.05 × 10⁻¹ |

TABLE 4
Fitted parameters for the equivalent circuit to impedance data for baseline
and ALD-coated at 650° C..

| | | ALD- | ALD- | ALD- | ALD- | ALD- |
|---|---|---|---|---|---|---|
| Fitting | Baseline | coated | coated | coated | coated at | coated |
| parameter | at 4 h | at 4 h | at 24 h | at 96 h | 648 h | at 816 h |
| Rₛ (Ω cm²) | 0.2430 | 0.1714 | 0.1711 | 0.1728 | 0.1764 | 0.1779 |
| f1 (Hz) | 30237.94 | 24138.00 | 24352.05 | 24590.90 | 25757.11 | 24825.01 |
| R1 (Ω cm²) | 0.045 | 0.043 | 0.045 | 0.045 | 0.045 | 0.049 |
| Q1 | 0.0341 | 0.0002 | 0.0001 | 0.0001 | 0.0002 | 0.0002 |
| n1 | 0.53 | 1.00 | 1.00 | 1.00 | 0.98 | 0.98 |
| C (F cm⁻²) | 1.18 × 10⁻⁴ | 1.54 × 10⁻⁴ | 1.46 × 10⁻⁴ | 1.44 × 10⁻⁴ | 1.37 × 10⁻⁴ | 1.31 × 10⁻⁴ |
| f2 (Hz) | 3701.16 | 4506.44 | 4259.86 | 4334.55 | 4564.91 | 4318.68 |
| R2 (Ω cm²) | 0.139 | 0.052 | 0.060 | 0.060 | 0.050 | 0.060 |
| Q2 | 0.0086 | 0.0007 | 0.0006 | 0.0006 | 0.0007 | 0.0006 |
| n2 | 0.67 | 1.00 | 1.00 | 1.00 | 1.00 | 1.00 |
| C (F cm⁻²) | 3.09 × 10⁻⁴ | 6.77 × 10⁻⁴ | 6.22 × 10⁻⁴ | 6.11 × 10⁻⁴ | 6.95 × 10⁻⁴ | 6.14 × 10⁻⁴ |
| f3 (Hz) | 202.92 | 705.37 | 565.05 | 716.90 | 1590.69 | 1133.53 |
| R3 (Ω cm²) | 0.015 | 0.106 | 0.103 | 0.098 | 0.093 | 0.086 |
| Q3 | 0.0523 | 0.0425 | 0.0568 | 0.0446 | 0.0168 | 0.0238 |
| n3 | 1.00 | 0.64 | 0.63 | 0.65 | 0.70 | 0.70 |
| C (F cm⁻²) | 5.23 × 10⁻³ | 2.13 × 10⁻³ | 2.75 × 10⁻³ | 2.27 × 10⁻³ | 1.08 × 10⁻³ | 1.63 × 10⁻³ |
| f4 (Hz) | 28.21 | 17.20 | 16.35 | 18.18 | 27.22 | 24.93 |
| R4 (Ω cm²) | 0.127 | 0.132 | 0.126 | 0.125 | 0.129 | 0.125 |
| Q4 | 0.0952 | 0.2260 | 0.2430 | 0.2490 | 0.2630 | 0.2690 |
| n4 | 0.85 | 0.75 | 0.75 | 0.73 | 0.66 | 0.67 |
| C (F cm⁻²) | 4.46 × 10⁻² | 7.01 × 10⁻² | 7.71 × 10⁻² | 7.01 × 10⁻² | 4.53 × 10⁻² | 5.11 × 10⁻² |
| f5 (Hz) | 1.74 | 2.02 | 1.97 | 2.03 | 2.21 | 2.17 |
| R5 (Ω cm²) | 0.119 | 0.112 | 0.120 | 0.130 | 0.148 | 0.147 |
| Q5 | 0.9980 | 0.7330 | 0.7450 | 0.7330 | 0.7250 | 0.7330 |
| n5 | 0.89 | 0.98 | 0.96 | 0.92 | 0.85 | 0.85 |
| C (F cm⁻²) | 7.66 × 10⁻¹ | 7.04 × 10⁻¹ | 6.73 × 10⁻¹ | 6.04 × 10⁻¹ | 4.88 × 10⁻¹ | 4.98 × 10⁻¹ |

### Example 6. Calculation of the Conductivity of an ALD Film

Eq. (1) was used to describe the contribution of each part of col (anode/electrolyte/cathode) for the uncoated cell.

R_{Baseline}=R_{LSCF}+R_{anode}+R_{electrolyte} Eq. (1)

Where R can be expressed as RₛL/W for each component as:

$$R {s}_{T o t b a s e} * \frac{L}{W} = R {s}_{L S C F} * \frac{L}{W} + R {s}_{anode} * \frac{L}{W} + R {s}_{e l ectrolyte} * \frac{L}{W} \qquad Eq . ( 2 )$$

Since L/W ratios are in the same magnitude for each component, we could further simplify the equation. Thus:

Rs_{Totbase}=Rs_{LSCF}+Rs_{anode}+Rs_{electrolyte} Eq. (3)

Eq. (3) corresponding to the uncoated cell has all of its components in series. In the other hand, for Eq. (4) we consider the composite of ALD coating and LSCF as an equivalent circuit in parallel since the ALD coating is deposited in the LSCF cathode. Thus, the equation for the ALD-coated cell is as follow:

R_{ALDcoated}=R_{composite}+R_{anode}+R_{electrolyte} Eq. (4)

Where the equivalent circuit for the ALD/LSCF contribution R_{composite} IS:

$${R}_{composite} = \frac{1}{[ \frac{1}{{R}_{L S C F}} + \frac{1}{{R}_{film}} ]} = \frac{1}{[ \frac{{R}_{L S C F} + {R}_{film}}{{R}_{L S C F} {R}_{film}} ]} = [ \frac{{R}_{L S C F} {R}_{film}}{{R}_{L S C F} + {R}_{film}} ] = \frac{L}{W} * [ \frac{R {s}_{L S C F} R {s}_{film}}{R s L SCF + R {s}_{film}} ] \qquad Eq . ( 5 )$$

If we substitute Eq. (5) into Eq. (4), and R is expressed as RₛL/W for each component:

$$R {s}_{ALDcoated} * \frac{L}{W} = \frac{L}{W} * [ \frac{R {s}_{film} R {s}_{L S C F}}{R {s}_{L S C F} + R {s}_{f i l m}} ] * \frac{L}{W} + {R}_{anode} * \frac{L}{W} + {R}_{electrolyte} * \frac{L}{W} \qquad Eq . ( 6 )$$

Similar to the baseline cell, the LAW ratios are in the same magnitude for each component. Additionally, from the results obtained in the main manuscript we can consider:

Rs_{ALDcoated}=0.068/0.112Rs_{Totbase} Eq. (7)

Thus, with the incorporation of Eq. (7), we have the following equation for the contribution in the ALD-coated cell:

$$R {s}_{A L D coated} = [ \frac{R {s}_{film} R {s}_{L S C F}}{R {s}_{L S C F} + R {s}_{film}} ] + R {s}_{anode} + R {s}_{electrolyte} = 0.0 \; 68 / 0.112 R {s}_{T o t b a s e} \qquad Eq . ( 8 )$$

The only different contributing factors between Rs_{ALDcoated} and Rs_{Totbase} is the LSCF and the ALD film. Additionally, by combining Rs_{anode}+Rs_{electrolyte} in Eq. (3) and Eq. (8), we have the following equation:

$$R {s}_{T o t b a s e} - {Rs}_{L S C F} = 0.6 \; 071 {Rs}_{T o t b a s e} - [ \frac{R {s}_{film} R {s}_{L S C F}}{R {s}_{L S C F} + R {s}_{film}} ] \qquad Eq . ( 9 )$$

Further simplification of the Eq. (9) can lead to:

$$[ \frac{R {s}_{film} R {s}_{L S C F}}{R {s}_{L S C F} + R {s}_{film}} ] = R {s}_{L S C F} - 0.3 \; 928 {Rs}_{T o t b a s e} \qquad Eq . ( 10 )$$

$$\frac{R {s}_{film}}{R {s}_{L S C F} + R {s}_{film}} = ( R {s}_{L S C F} - 0.3 \; 928 {Rs}_{T o t b a s e} ) / {Rs}_{L S C F} \qquad Eq . ( 11 )$$

$$\frac{R {s}_{L S C F} + R {s}_{film}}{R {s}_{film}} = R {s}_{L S C F} / ( {Rs}_{L S C F} - 0.3 \; 928 {Rs}_{T o t b a s e} ) \qquad Eq . ( 12 )$$

$$\frac{R {s}_{L S C F}}{R {s}_{film}} = [ R {s}_{L S C F} / ( {Rs}_{L S C F} - 0.3 \; 928 {Rs}_{T o t b a s e} ) ] - 1 \qquad Eq . ( 13 )$$

$$R {s}_{film} = R {s}_{L S C F} / \{ [ R {s}_{L S C F} / ( {Rs}_{L S C F} - 0.3 \; 928 {Rs}_{T o t b a s e} ) ] - 1 \} \qquad Eq . ( 14 )$$

The resistivity values can be expressed for each component as p=Rs*t. Thus, if we replace Rs=p/t in Eq. (14), we have the following equation.

ρ_{film}=t_{film}(ρ_{LSCF}/t_{LSCF})/{[(ρ_{LSCF}/t_{LSCF})/((ρ_{LSCF}/t_{LSCF})−0.3928ρ_{Totbase}/t_{Totbase})]−1} Eq. (15)

t_{film} can be approximated as a fraction of t_{LSCF} in accordance to the area ratio between the LSCF and the ALD film calculated from the TEM images shown in the manuscript. This approach limits the big difference of the actual volume between LSCF cathode and ALD-coated cathode. Additionally, from the manufacturer, we could obtain the thickness of the LSCF and the whole thickness of the cell. The μ_{LSCF} value is obtained from literature (Ref. 48) while the ρ_{Totbase} is calculated from Rs=p/t.

The resistivity value for the film can be calculated employing Eq. (15). The resultant resistivity value obtained for the film is ρ_{film}=7.87×10⁻⁵ Ωcm, such value represents a ratio of μ_{LSCF}/ρ_{film} of 127. However, the conductivity value for the film is 1.27×10⁶ S/m. Accordingly, we can conclude that the ALD film layer is 127 times more conductive than the LSCF cathode.

### Example 7. Discussion

The ability to manipulate the surface chemistry of the mixed conductor and suppress its degradation related to the intrinsic Sr surface segregation is critical for the SOFCs. The disclosed ALD-coated cells demonstrate that, for the inherent functional SOFC with a mixed conducting composite cathode, the electrocatalytic nanoionics with high-density grain boundaries can be precisely introduced onto the cathode backbone. The conformal thin-film surface nanoionics can be controlled to have the single-layered, randomly orientated nanograins to maximize the contribution of surface grain boundaries and the interface strains to the conductivity and the electrocatalytic activities. The conformal ALD layer completely shifted the ORR reduction pathways. It also served as the effective barrier layer for backbone cations outward diffusion. Most importantly, the ALD coating turns the original perovskite surface that is vulnerable to cation segregation and degradation into an embedded strained interface phase with enormous conductivity. For the first time in the field of SOFC, the disclosed ALD-coated cells demonstrate an effective approach for solving multiple-problems for successfully suppressing the Sr surface segregation of mixed conductors, preventing Cr contamination, and simultaneously increasing the conductivity. The high-density surface and intergranular grain boundaries of the strained ALD layer provided an enormous surface area

1. A coated electrode comprising:
an electrode comprising a nanocomposite coating;
wherein the nanocomposite coating comprises:
a layered coating comprising:
a first coating layer; and
a second coating layer;
wherein the first coating layer comprises discrete nanoparticles;
wherein the discrete nanoparticles comprise Pt, Ag, Au, or combinations thereof;
wherein the second coating layer forms a continuous conformal layer comprising metal oxide nanograins;
wherein the metal oxide nanograins comprise Co_{y}Oₓ; doped Co_{y}Oₓ; Pr_{y}Oₓ; doped Pr_{y}Oₓ; Ce_{y}Oₓ; doped Ce_{y}Oₓ; La_{y}Ni_{z}Oₓ; doped La_{y}Ni—Oₓ; or combinations thereof;
wherein the first coating layer is subjacent to the second coating layer; and
wherein the second coating layer is superjacent to the first coating layer, thereby capping the first coating layer.

2. The coated electrode of claim 1, wherein the layered coating has a total thickness of from about 1 nm to about 200 nm.

3.-4. (canceled)

5. The coated electrode of claim 2, wherein the layered coating has a total thickness of from about 5 nm to about 20 nm.

6. The coated electrode of claim 1, wherein the continuous conformal layer comprises metal oxide nanograins distributed as a single-layer.

7. The coated electrode of claim 1, wherein the discrete nanoparticles are elongated discrete nanoparticles.

8. The coated electrode of claim 7, wherein the elongated discrete nanoparticles are from about 1 nm to about 100 nm in their longest dimension.

9. The coated electrode of claim 1, wherein the metal oxide nanograins are elongated metal oxide nanograins.

10. The coated electrode of claim 9, wherein the elongated metal oxide nanograins are from about 1 nm to about 200 nm in their longest dimension.

11.-14. (canceled)

15. The coated electrode of claim 1, wherein the metal oxide nanograins are separated from one another by from about 0.001 nm to about 1 nm.

16. The coated electrode of claim 1, wherein the metal oxide nanograins are in contact with one another via intergrain boundaries.

17. (canceled)

18. The coated electrode of claim 1, wherein the metal oxide nanograins comprise mixed valence metal oxide nanograins.

19. The coated electrode of claim 18, wherein the mixed valence metal oxide nanograins comprise at least two of Ce_{y}Oₓ; Co_{y}Oₓ; or Pr_{y}Oₓ.

20.-34. (canceled)

35. The coated electrode of claim 18, wherein the mixed valence metal oxide nanograins comprise La_{y}Ni_{z}Oₓ.

36.-41. (canceled)

42. The coated electrode of claim 1, wherein a doped metal oxide nanograin comprises a dopant selected from Ni, Fe, and a combination thereof.

43. The coated electrode of claim 1, wherein the second coating layer is essentially free from both Sr and La.

44. The coated electrode of claim 1, wherein the electrode is a cathode.

45. The coated electrode of claim 1, wherein the electrode is a cobaltite-based perovskite electrode.

46. The coated electrode of claim 45, wherein the cobaltite-based perovskite electrode comprises lanthanum strontium cobalt ferrite (LSCF).

47. (canceled)

48. A product comprising the electrode of claim 1.

49.-56. (canceled)

57. A method of making the coated electrode of claim 1, the method comprising:
providing an electrode in an atomic layer deposition reaction chamber;
performing at least one atomic layer deposition cycle to form a first coating layer on a surface of the substrate;
wherein the first coating layer comprises discrete nanoparticles;
wherein the discrete nanoparticles comprise Pt, Ag, Au, or combinations thereof;
performing at least one atomic layer deposition cycle to form a second coating layer on the first coating layer;
wherein the second coating layer comprises metal oxide nanograins;
wherein the metal oxide nanograins comprise Co_{y}Oₓ; doped Co_{y}Oₓ; Pr_{y}Oₓ; doped Pr_{y}Oₓ; CeOₓ; doped CeOₓ; La_{y}Ni_{z}Oₓ; doped La_{y}Ni_{z}Oₓ; or combinations thereof; and
wherein the second coating layer forms a continuous conformal layer comprising metal oxide nanograins on the first coating layer;
wherein the first coating layer is subjacent to the second coating layer; and
wherein the second coating layer is superjacent to the first coating layer, thereby capping the first coating layer;
wherein the first coating layer is superjacent to the substrate.
